(19) United States
(12) Patent Application Publication
(10) Pub. No.: US 2015/0178052 A1
(43) Pub. Date: Jun. 25, 2015

(54) AUTOMATED EXPERIMENTATION PLATFORM

(71) Applicant: ATIGEO LLC, Bellevue, WA (US)

(72) Inventors: Gunjan Gupta, Bellevue, WA (US); Aman Thakral, Bellevue, WA (US); John Morris, Bellevue, WA (US); Robert Payne, Bellevue, WA (US); Michael Sandoval, Bellevue, WA (US); David Talby, Bellevue, WA (US); Vishnu Vettrivel, Bellevue, WA (US)

(73) Assignee: ATIGEO LLC, Bellevue, WA (US)

(21) Appl. No.: 14/574,297

(22) Filed: Dec. 17, 2014

Related U.S. Application Data
(60) Provisional application No. 61/916,888, filed on Dec. 17, 2013.

(51) Int. Cl. G06F 9/44; H04L 29/08

(52) U.S. Cl. CPC G06F 8/34; H04L 67/10

(57) ABSTRACT

The present document is directed to an automated experimentation platform that provides a visual integrated development environment (“IDE”) that allows a user to construct and execute various types of data-driven workflows. The automated experimentation platform includes back-end components that include API servers, a catalog, a cluster-management component, and execution-cluster nodes. Workflows are visually represents as directed acyclic graphs and texturally encoded. The workflows are transformed into jobs that are distributed for execution to the execution-cluster nodes.

### CROSS-REFERENCE TO RELATED APPLICATION

This application claims the benefit of Provisional Application No. 61/916,888, filed Dec. 17, 2013.

### TECHNICAL FIELD

The present document is related to computational systems and, in particular, to an automated experimentation platform that provides a visual integrated development environment which allows a user to construct and execute data-driven workflows.

### BACKGROUND

Data processing has evolved, over the past 60 years, from relying on largely ad hoc program that use basic operating-system functionality and hand-coded data-processing routines to an enormous variety of different types of higher-level automated data-processing environments, including various generalized data-processing applications and utilities and tools associated with database management systems. However, many of these automated data-processing systems are associated with significant constraints, including constraints with regard to specification of data-processing procedures, data models, data types, and other such constraints. Moreover, most automated systems still involve a large amount of problem-specific coding to specify data-processing steps as well as data transformations needed to direct data to particular types of functionality associated with particular interfaces. As a result, those who design and develop data-processing systems and tools as well as those who use them continue to seek new data-processing systems and functionalities.

### SUMMARY

The present document is directed to an automated experimentation platform that provides a visual integrated development environment (“IDE”) that allows a user to construct and execute various types of data-driven workflows. The automated experimentation platform includes back-end components that include API servers, a catalog, a cluster-management component, and execution-cluster nodes. Workflows are visually represents as directed acyclic graphs and texturally encoded. The workflows are transformed into jobs that are distributed for execution to the execution-cluster nodes.

### BRIEF DESCRIPTION OF THE DRAWINGS

FIG. 1 shows an example workflow created by a user of the currently disclosed automated experimentation platform.

FIG. 2 illustrates how, following a run of the experiment shown in FIG. 1, a user can modify the experiment by substituting, for input data set 102 in FIG. 1, a new input data set 202.

FIG. 3 shows a dashboard view of the second workflow, shown in FIG. 2.

FIG. 4 provides a general architectural diagram for various types of computers.

FIG. 5 illustrates an Internet-connected distributed computer system.

FIG. 6 illustrates cloud computing.

FIG. 7 illustrates generalized hardware and software components of a general-purpose computer system, such as a general-purpose computer system having an architecture similar to that shown in FIG. 1.

FIGS. 8A-B illustrate two types of virtual machine and virtual-machine execution environments.

FIG. 9 illustrates electronic communications between a client and server computer.

FIG. 10 illustrates the role of resources in RESTful APIs.

FIGS. 11A-D illustrate four basic verbs, or operations, provided by the HTTP application-layer protocol used in RESTful applications.

FIG. 12 illustrates the main components of the scientific-workflow system to which the current document is directed.

FIGS. 13A-E illustrate the JSON encoding of a relatively simple six-node experiment DAG.

FIGS. 14A-D illustrate the metadata that is stored in the catalog service (1226 in FIG. 12).

FIGS. 15A-1 provide an example of an experiment layout DAG corresponding to an experiment DAG, such as the experiment DAG discussed above with reference to FIGS. 13C-D.

FIGS. 16A-I illustrate the process of experiment design and execution within the scientific-workflow system.

FIGS. 17A-B show a sample visual representation of an experiment DAG and the corresponding JSON encoding of the experiment DAG.

FIGS. 18A-G illustrate the activities carried out by the API-server component (1608 in FIG. 16A) of the scientific-workflow-system back end following submission of an experiment for execution by a user via a front-end experiment-dashboard application.

FIG. 19 provides a control-flow diagram for the routine “cluster manager” which executes on the cluster-manager component of the scientific-workflow-system back end to distribute jobs to execution cluster nodes for execution.

FIG. 20 provides a control-flow diagram for the routine “pinger.”

FIG. 21 provides a control-flow diagram for the routine “executor” that launches execution of jobs on an execution-cluster node.

### DETAILED DESCRIPTION

The present document is directed to an automated experimentation platform that allows users to conduct data-driven experiments. The experiments are complex computational tasks, and are assembled as workflows by a user through a visual IDE. The model underlying this visual IDE and the automated experimentation platform, in general, includes three basic entities: (1) input data sets; (2) generated data sets, including intermediate and output data sets; and (3) execution modules with configurations. Once a workflow is graphically constructed, the automated experimentation platform executes the workflow and produces output data sets. Configured execution modules are converted, by a run-time instance of an experiment, into jobs. These jobs are executed and monitored by the automated experimentation platform, and can be executed either locally, on the same computer system in which the automated experimentation platform is incorporated, or remotely, on remote computer systems. In other words, execution of workflows may map to distributed computing components. In certain implementations, the automated experimentation platform is, itself, distributed across multiple computer systems. The automated experimentation platform can run multiple jobs and multiple workflows, in parallel, and includes sophisticated logic for avoiding redundant generation of datasets and redundant execution of jobs, when needed datasets have already been generated and catalogued by the automated experimentation platform.

The execution modules can be written in any of a very wide variety of different languages, including python, java, hive, mysql, scala, spark, and other programming languages. The automated experimentation platform automatically handles data transformations needed for input of data into various types of execution modules. The automated execution platform additionally includes versioning components that recognize and catalog different versions of experiments, implemented as workflows, execution modules, and data sets, so that an entire history of experimentation can be accessed by users for re-use and re-execution as well as for building new experiments based on previous experiments, execution modules, and data sets.

The automated experimentation platform provides dashboard capabilities that allow users to upload and download execution modules from and to a local machine as well as to upload and download input, intermediate, and output data sets from and to a local machine. In addition, a user can search for execution modules and data sets by name, by values for one or more attributes associated with the execution modules and user data sets, and by description. Existing workflows can be cloned and portions of existing workflows can be extracted and modified in order to create new workflows for new experiments. The visual workflow-creation facilities provided by the automated experimentation platform vastly increases user productivity by allowing users to quickly design and execute complex data-driven processing tasks. In addition, because the automated experimentation platform can identify potential duplication of execution and duplicate data, significant computational efficiency is obtained versus hand-coded or less intelligent automated data-processing systems. In addition, the automated experimentation platform allows user to collaborate, as teams, to publish, share, and cooperatively create experiments, workflows, data sets, and execution modules.

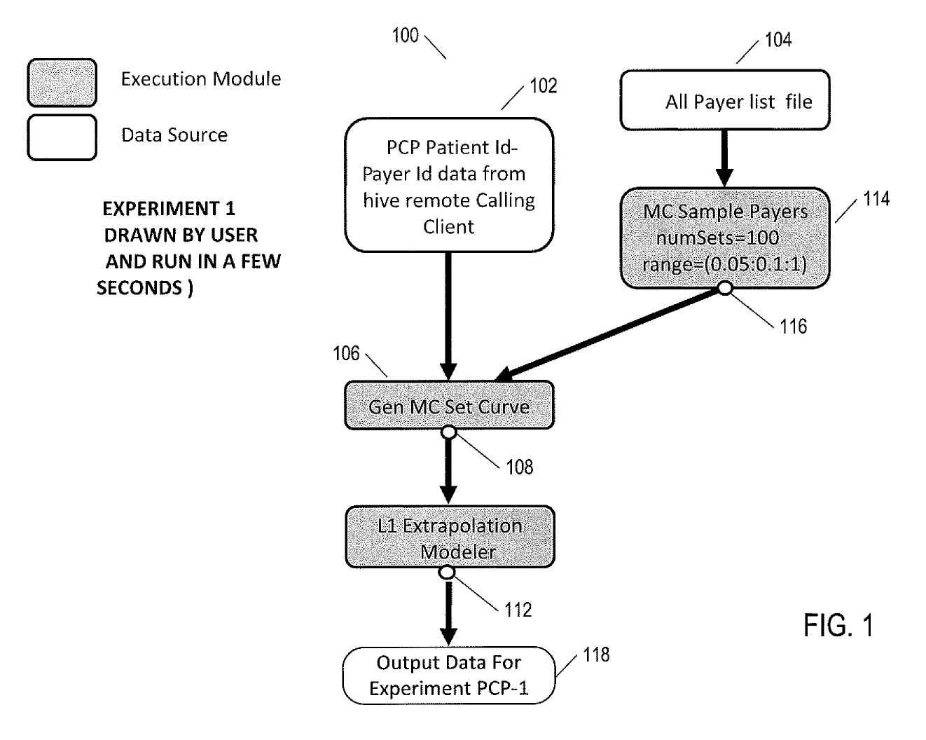

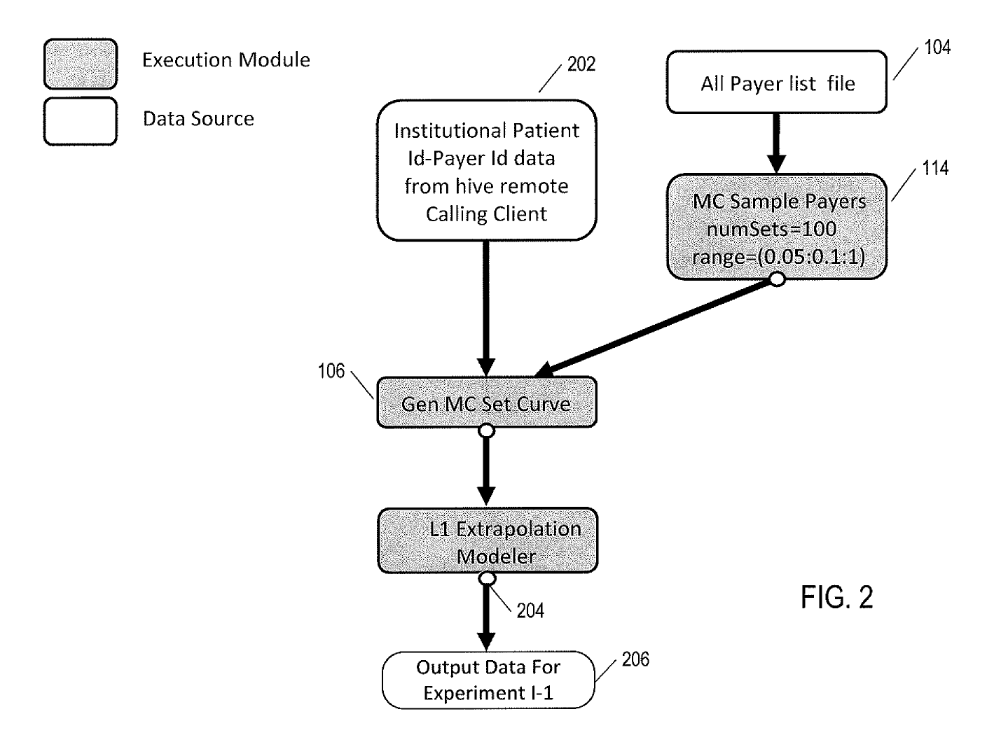

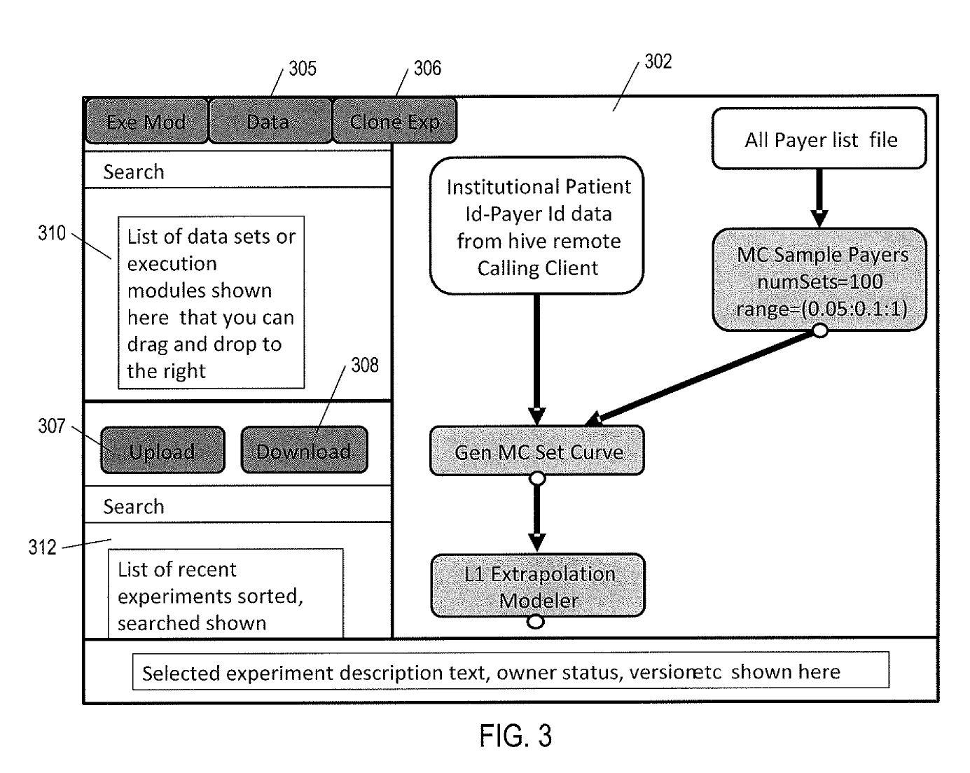

FIG. 1 shows an example workflow created by a user of the currently disclosed automated experimentation platform. FIG. 1, and FIGS. 2-3, discussed below, show the workflow as the workflow would be displayed to a user through the graphical user interface of the visual IDE provided by the automated experimentation platform. In FIG. 1, the workflow 100 includes two input data sets 102 and 104. The first input data set 102 is input to a first execution module 106 which, in the illustrated example, produces an intermediate data set, represented by circle 108, that consists of results sets of a Monte-Carlo simulation. Intermediate data set 108 is then input to a second execution module 110 that produces an output data set 112. The second input data set 104 is processed by a third execution module 114 which generates a second intermediate data set 116, in this case a large file continuing the results of a very large number of Monte-Carlo simulations. The second intermediate data set 116 is input, along with input data set 102, to execution module 106.

As shown in FIG. 2, following a run of the experiment shown in FIG. 1, a user can modify the experiment by substituting, for input data set 102 in FIG. 1, a new input data set 202. The user can then execute the new workflow to produce a new output data set 204. In this case, because there were no changes to the second input data set 104 and third execution module 114, execution of the second workflow does not involve re-input of the second input data set 104 to the third execution module 114 and execution of the third execution module 114. Instead, the intermediate data set 116 previously produced by execution of the third execution module can be retrieved from a catalogue of previously produced intermediate data sets and input to the second execution module 106 during a run of the second workflow shown in FIG. 2. Note that the three execution modules 106, 110, and 114 may have been programmed in different languages and may be run on different physical computer systems. Note also that the automated experimentation platform is responsible for determining the types of the input data sets 102 and 104 and ensuring that, when necessary, these data sets are appropriately modified in order to have the proper format and data types needed by the execution modules 106 and 114, into which they are input during execution of the workflow.

FIG. 3 shows a dashboard view of the second workflow, shown in FIG. 2. As can be seen in FIG. 3, the workflow is displayed visually to the user in a workflow-display panel 302. In addition, the dashboard provides a variety of tools with corresponding input and manipulation features 304-308 as well as additional display windows 310 and 312 that display information relevant to various tasks and operations carried out by a user using the input and manipulation features.

In two following subsections, overviews of the hardware platforms and RESTful communications used in a described implementation of the automated experimentation platform to which the current document is directed. A final subsection described an implementation of the automated experimentation platform to which the current document is directed, referred to as the “scientific-workflow system.”

Computer Hardware, Distributed Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modem technology and science to misinterpret the terms “abstract” and “abstraction,” when used to describe certain aspects of modem computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

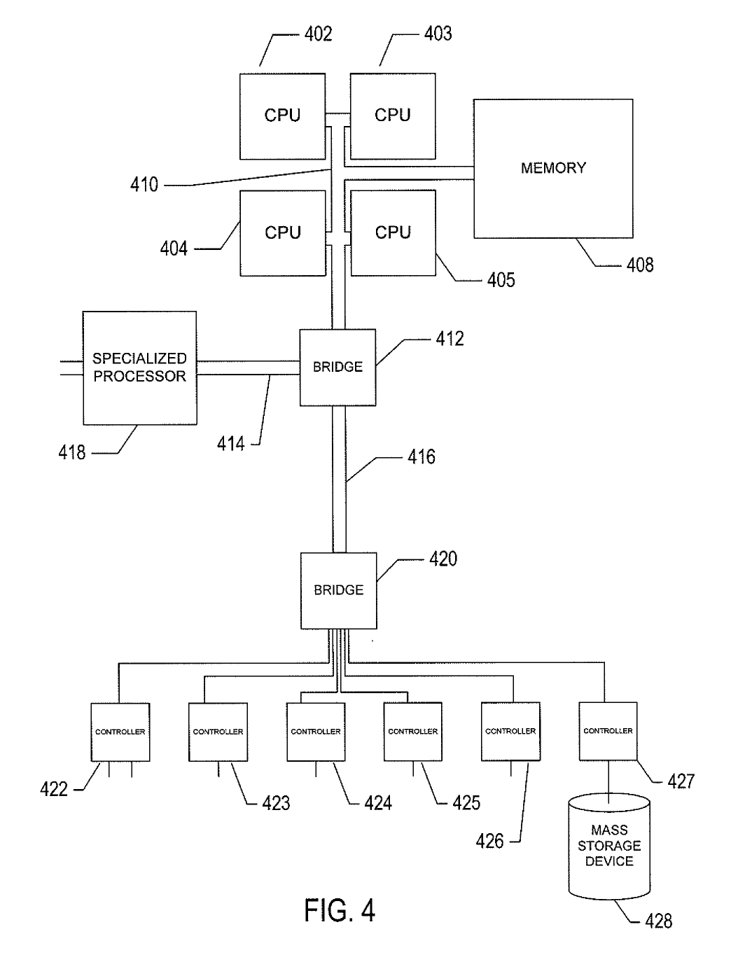

FIG. 4 provides a general architectural diagram for various types of computers. Computers within cloud-computing facilities may be described by the general architectural diagram shown in FIG. 4, for example. The computer system contains one or multiple central processing units (“CPUs”) 402-405, one or more electronic memories 408 interconnected with the CPUs by a CPU/memory-subsystem bus 410 or multiple busses, a first bridge 412 that interconnects the CPU/memory-subsystem bus 410 with additional busses 414 and 416, or other types of high-speed interconnection media, including multiple, high-speed serial interconnects. These busses or serial interconnections, in turn, connect the CPUs and memory with specialized processors, such as a graphics processor 418, and with one or more additional bridges 420, which are interconnected with high-speed serial links or with multiple controllers 422-427, such as controller 427, that provide access to various different types of mass-storage devices 428, electronic displays, input devices, and other such components, subcomponents, and computational resources. It should be noted that computer-readable data-storage devices include optical and electromagnetic disks, electronic memories, and other physical data-storage devices. Those familiar with modem science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

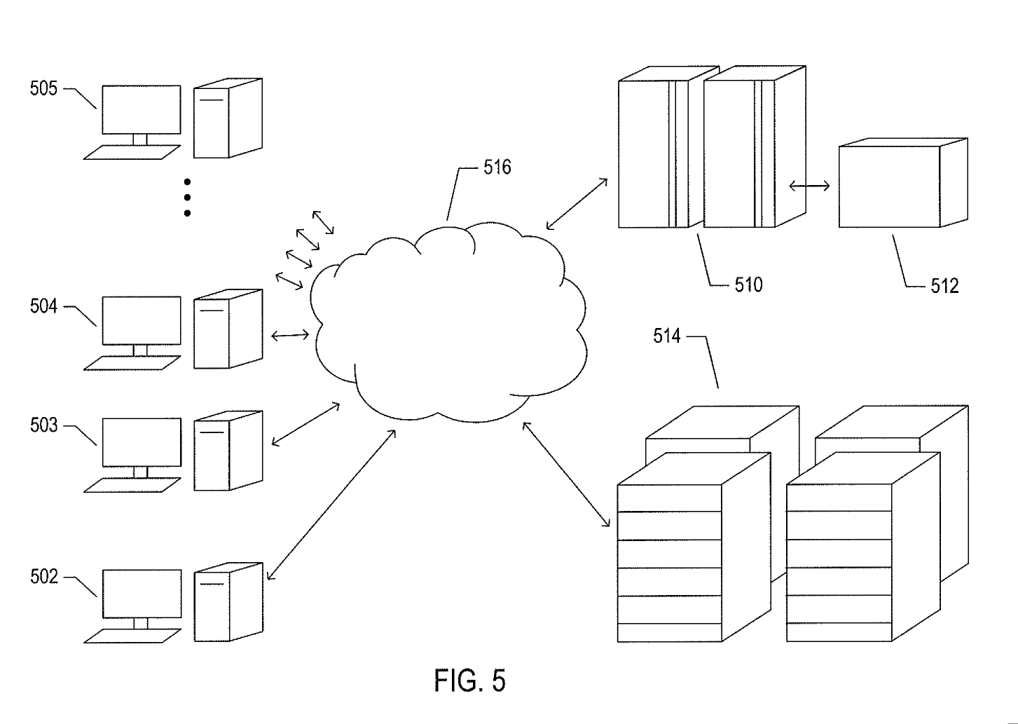

FIG. 5 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modem computing now generally involves large distributed systems and computers interconnected by local networks, wide-area networks, wireless communications, and the Internet. FIG. 5 shows a typical distributed system in which a large number of PCs 502-505, a high-end distributed mainframe system 510 with a large data-storage system 512, and a large computer center 514 with large numbers of rack-mounted servers or blade servers all interconnected through various communications and networking systems that together comprise the Internet 516. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

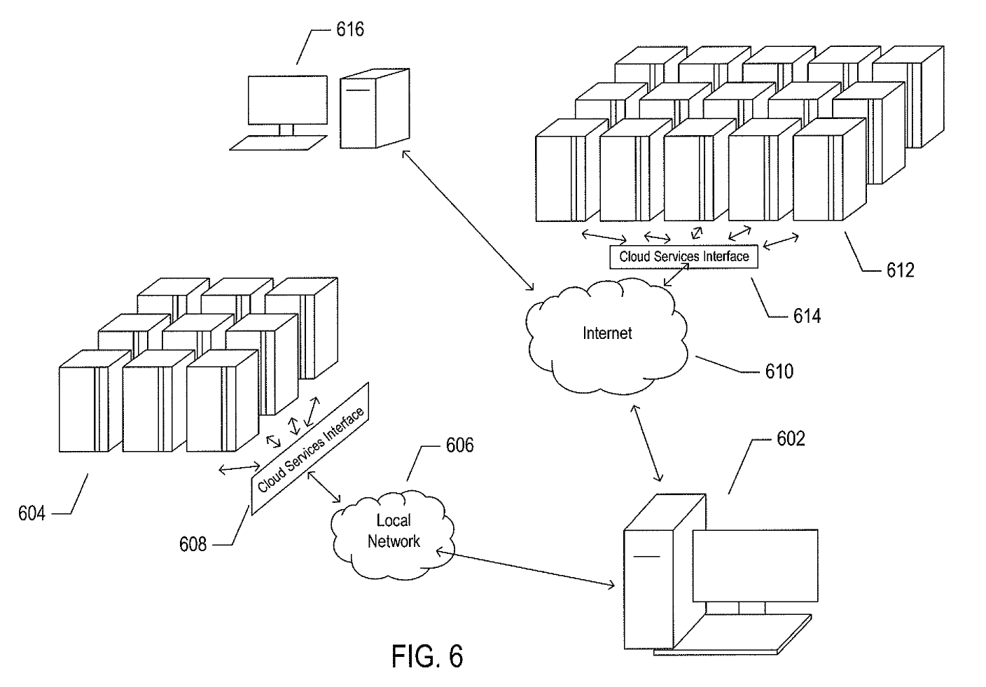

FIG. 6 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of subscribing to computing services provided by public cloud-computing service providers. In FIG. 6, a system administrator for an organization, using a PC 602, accesses the organization's private cloud 604 through a local network 606 and private-cloud interface 608 and also accesses, through the Internet 610, a public cloud 612 through a public-cloud services interface 614. The administrator can, in either the case of the private cloud 604 or public cloud 612, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 616.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

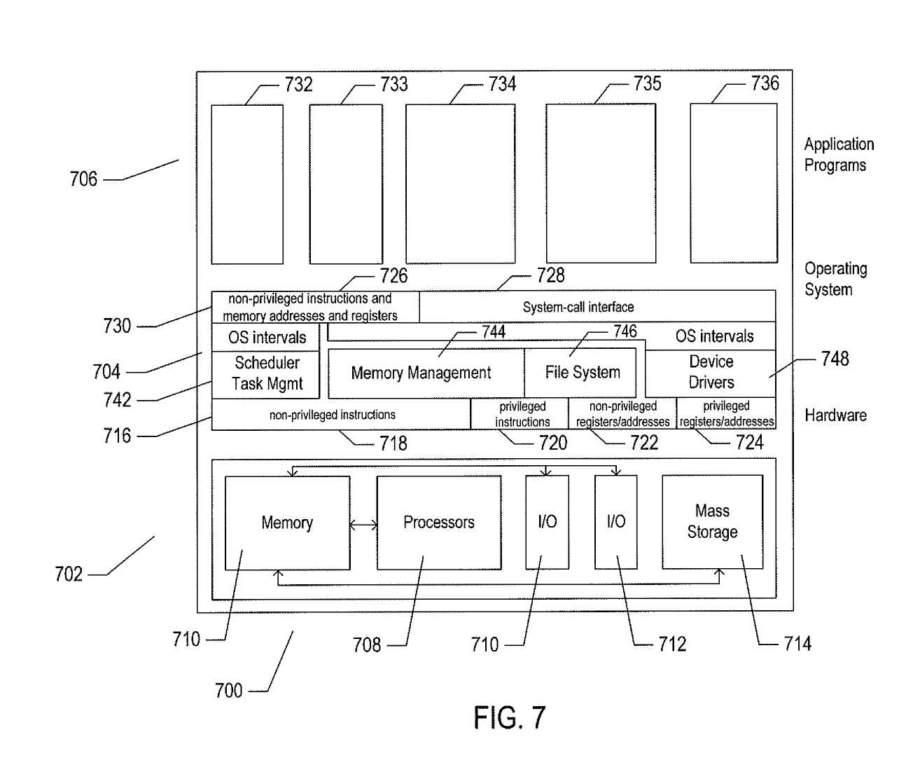

FIG. 7 illustrates generalized hardware and software components of a general-purpose computer system, such as a general-purpose computer system having an architecture similar to that shown in FIG. 1. The computer system 700 is often considered to include three fundamental layers: (1) a hardware layer or level 702; (2) an operating-system layer or level 704; and (3) an application-program layer or level 706. The hardware layer 702 includes one or more processors 708, system memory 710, various different types of input-output (“I/O”) devices 710 and 712, and mass-storage devices 714. Of course, the hardware level also includes many other components, including power supplies, internal communications links and busses, specialized integrated circuits, many different types of processor-controlled or microprocessor-controlled peripheral devices and controllers, and many other components. The operating system 704 interfaces to the hardware level 702 through a low-level operating system and hardware interface 716 generally comprising a set of non-privileged computer instructions 718, a set of privileged computer instructions 720, a set of non-privileged registers and memory addresses 722, and a set of privileged registers and memory addresses 724. In general, the operating system exposes non-privileged instructions, non-privileged registers, and non-privileged memory addresses 726 and a system-call interface 728 as an operating-system interface 730 to application programs 732-736 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 742, memory management 744, a file system 746, device drivers 748, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 736 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

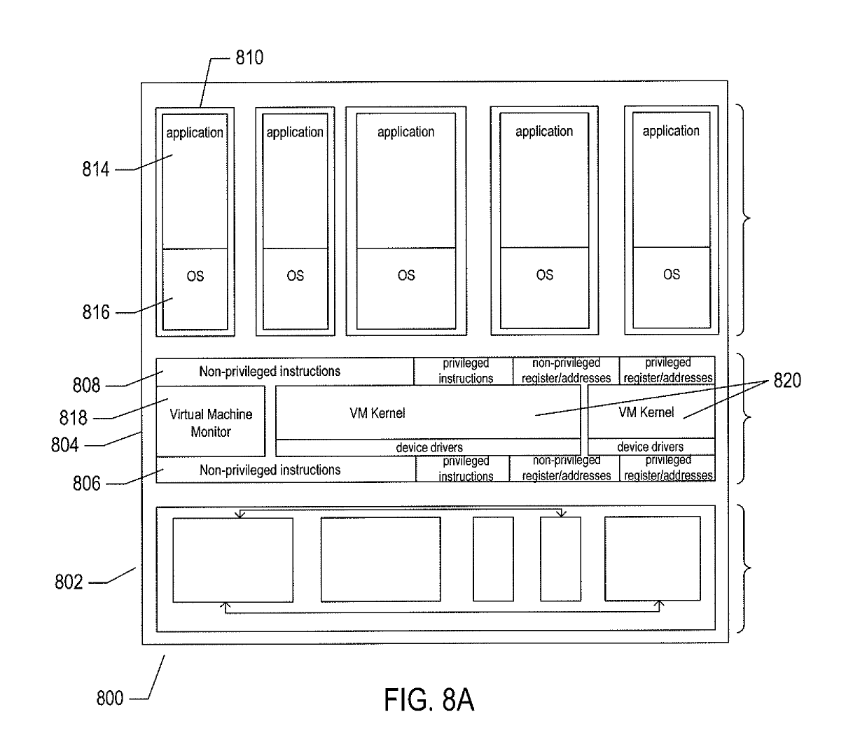

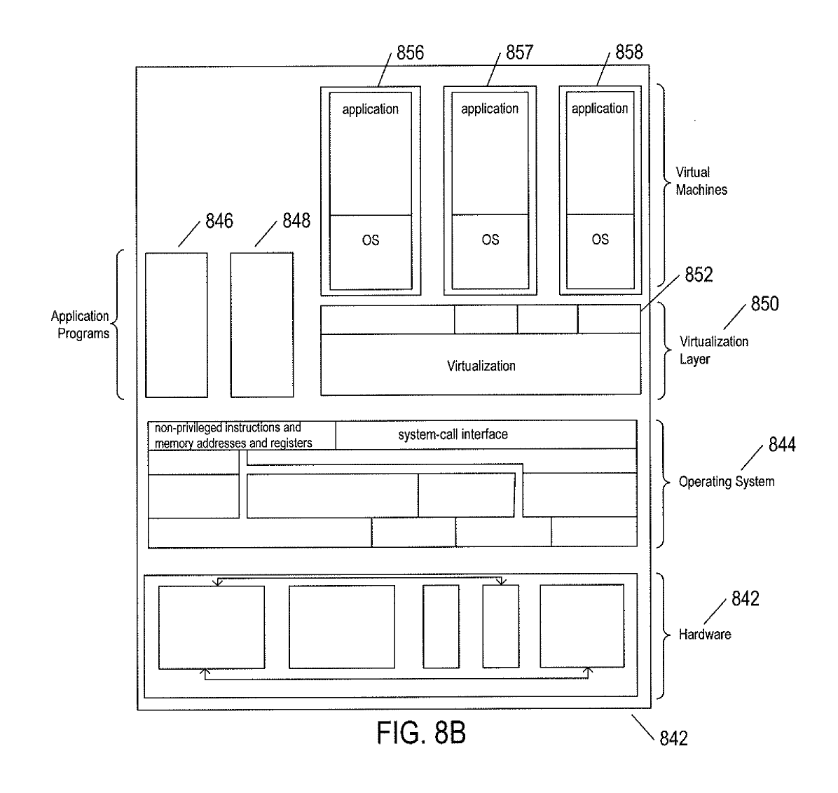

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 8A-B illustrate two types of virtual machine and virtual-machine execution environments. FIGS. 8A-B use the same illustration conventions as used in FIG. 7. FIG. 8A shows a first type of virtualization. The computer system 800 in FIG. 8A includes the same hardware layer 802 as the hardware layer 702 shown in FIG. 7. However, rather than providing an operating system layer directly above the hardware layer, as in FIG. 7, the virtualized computing environment illustrated in FIG. 8A features a virtualization layer 804 that interfaces through a virtualization-layer/hardware-layer interface 806, equivalent to interface 716 in FIG. 7, to the hardware. The virtualization layer provides a hardware-like interface 808 to a number of virtual machines, such as virtual machine 810, executing above the virtualization layer in a virtual-machine layer 812. Each virtual machine includes one or more application programs or other higher-level computational entities packaged together with an operating system, referred to as a “guest operating system,” such as application 814 and guest operating system 816 packaged together within virtual machine 810. Each virtual machine is thus equivalent to the operating-system layer 704 and application-program layer 706 in the general-purpose computer system shown in FIG. 7. Each guest operating system within a virtual machine interfaces to the virtualization-layer interface 808 rather than to the actual hardware interface 806. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 808 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 818 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 808, the accesses result in execution of virtualization-layer code to simulate or emulate the privileged resources. The virtualization layer additionally includes a kernel module 820 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 8B illustrates a second type of virtualization. In FIG. 8B, the computer system 840 includes the same hardware layer 842 and software layer 844 as the hardware layer 702 shown in FIG. 7. Several application programs 846 and 848 are shown running in the execution environment provided by the operating system. In addition, a virtualization layer 850 is also provided, in computer 840, but, unlike the virtualization layer 804 discussed with reference to FIG. 8A, virtualization layer 850 is layered above the operating system 844, referred to as the “host OS,” and uses the operating system interface to access operating-system-provided functionality as well as the hardware. The virtualization layer 850 comprises primarily a VMM and a hardware-like interface 852, similar to hardware-like interface 808 in FIG. 8A. The virtualization-layer/hardware-layer interface 852, equivalent to interface 716 in FIG. 7, provides an execution environment for a number of virtual machines 856-858, each including one or more application programs or other higher-level computational entities packaged together with a guest operating system.

In FIGS. 8A-B, the layers are somewhat simplified for clarity of illustration. For example, portions of the virtualization layer 850 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

### RESTful APIs

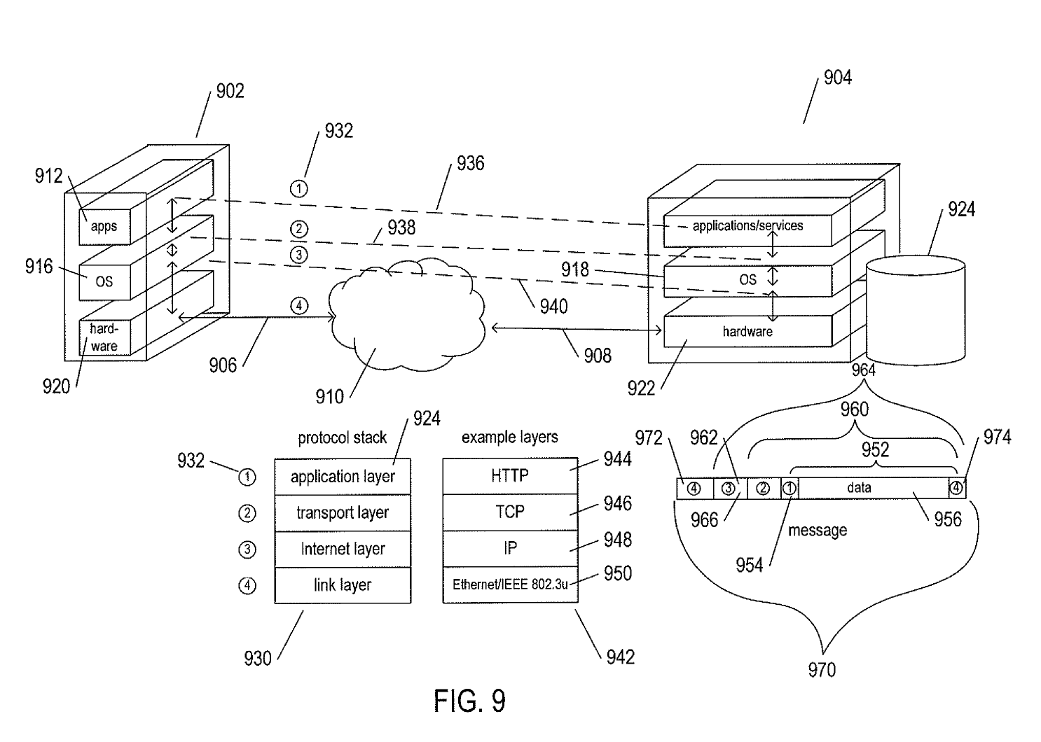

Electronic communications between computer systems generally comprises packets of information, referred to as datagrams, transferred from client computers to server computers and from server computers to client computers. In many cases, the communications between computer systems is commonly viewed from the relatively high level of an application program which uses an application-layer protocol for information transfer. However, the application-layer protocol is implemented on top of additional layers, including a transport layer, Internet layer, and link layer. These layers are commonly implemented at different levels within computer systems. Each layer is associated with a protocol for data transfer between corresponding layers of computer systems. These layers of protocols are commonly referred to as a “protocol stack.” In FIG. 9, a representation of a common protocol stack 930 is shown below the interconnected server and client computers 904 and 902. The layers are associated with layer numbers, such as layer number “1” 932 associated with the application layer 934. These same layer numbers are used in the depiction of the interconnection of the client computer 902 with the server computer 904, such as layer number “1” 932 associated with a horizontal dashed line 936 that represents interconnection of the application layer 912 of the client computer with the applications/services layer 914 of the server computer through an application-layer protocol. A dashed line 936 represents interconnection via the application-layer protocol in FIG. 9, because this interconnection is logical, rather than physical. Dashed-line 938 represents the logical interconnection of the operating-system layers of the client and server computers via a transport layer. Dashed line 940 represents the logical interconnection of the operating systems of the two computer systems via an Internet-layer protocol. Finally, links 906 and 908 and cloud 910 together represent the physical communications media and components that physically transfer data from the client computer to the server computer and from the server computer to the client computer. These physical communications components and media transfer data according to a link-layer protocol. In FIG. 9, a second table 942 aligned with the table 930 that illustrates the protocol stack includes example protocols that may be used for each of the different protocol layers. The hypertext transfer protocol (“HTTP”) may be used as the application-layer protocol 944, the transmission control protocol (“TCP”) 946 may be used as the transport-layer protocol, the Internet protocol 948 (“IP”) may be used as the Internet-layer protocol, and, in the case of a computer system interconnected through a local Ethernet to the Internet, the Ethernet/IEEE 802.3u protocol 950 may be used for transmitting and receiving information from the computer system to the complex communications components of the Internet. Within cloud 910, which represents the Internet, many additional types of protocols may be used for transferring the data between the client computer and server computer.

Consider the sending of a message, via the HTTP protocol, from the client computer to the server computer. An application program generally makes a system call to the operating system and includes, in the system call, an indication of the recipient to whom the data is to be sent as well as a reference to a buffer that contains the data. The data and other information are packaged together into one or more HTTP datagrams, such as datagram 952. The datagram may generally include a header 954 as well as the data 956, encoded as a sequence of bytes within a block of memory. The header 954 is generally a record composed of multiple byte-encoded fields. The call by the application program to an application-layer system call is represented in FIG. 9 by solid vertical arrow 958. The operating system employs a transport-layer protocol, such as TCP, to transfer one or more application-layer datagrams that together represent an application-layer message. In general, when the application-layer message exceeds some threshold number of bytes, the message is sent as two or more transport-layer messages. Each of the transport-layer messages 960 includes a transport-layer-message header 962 and an application-layer datagram 952. The transport-layer header includes, among other things, sequence numbers that allow a series of application-layer datagrams to be reassembled into a single application-layer message. The transport-layer protocol is responsible for end-to-end message transfer independent of the underlying network and other communications subsystems, and is additionally concerned with error control, segmentation, as discussed above, flow control, congestion control, application addressing, and other aspects of reliable end-to-end message transfer. The transport-layer datagrams are then forwarded to the Internet layer via system calls within the operating system and are embedded within Internet-layer datagrams 964, each including an Internet-layer header 966 and a transport-layer datagram. The Internet layer of the protocol stack is concerned with sending datagrams across the potentially many different communications media and subsystems that together comprise the Internet. This involves routing of messages through the complex communications systems to the intended destination. The Internet layer is concerned with assigning unique addresses, known as “IP addresses,” to both the sending computer and the destination computer for a message and routing the message through the Internet to the destination computer. Internet-layer datagrams are finally transferred, by the operating system, to communications hardware, such as a network-interface controller (“NIC”) which embeds the Internet-layer datagram 964 into a link-layer datagram 970 that includes a link-layer header 972 and generally includes a number of additional bytes 974 appended to the end of the Internet-layer datagram. The link-layer header includes collision-control and error-control information as well as local-network addresses. The link-layer packet or datagram 970 is a sequence of bytes that includes information introduced by each of the layers of the protocol stack as well as the actual data that is transferred from the source computer to the destination computer according to the application-layer protocol.

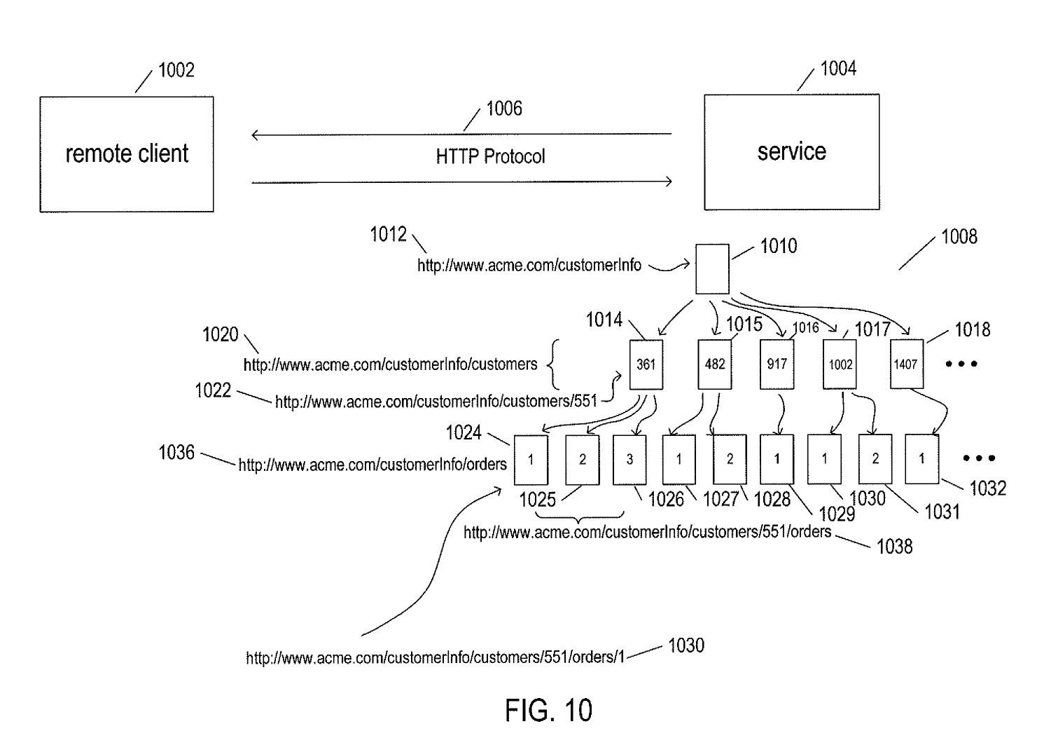

Next, the RESTful approach to web-service APIs is described, beginning with FIG. 10. FIG. 10 illustrates the role of resources in RESTful APIs. In FIG. 10, and in subsequent figures, a remote client 1002 is shown to be interconnected and communicating with a service provided by one or more service computers 1004 via the HTTP protocol 1006. Many RESTful APIs are based on the HTTP protocol. Thus, the focus is on the application layer in the following discussion. However, as discussed above with reference to FIG. 10, the remote client 1002 and service provided by one or more server computers 1004 are, in fact, physical systems with application, operating-system, and hardware layers that are interconnected with various types of communications media and communications subsystems, with the HTTP protocol the highest-level layer in a protocol stack implemented in the application, operating-system, and hardware layers of client computers and server computers. The service may be provided by one or more server computers, as discussed above in a preceding section. As one example, a number of servers may be hierarchically organized as various levels of intermediary servers and end-point servers. However, the entire collection of servers that together provide a service are addressed by a domain name included in a uniform resource identifier (“URI”), as further discussed below. A RESTful API is based on a small set of verbs, or operations, provided by the HTTP protocol and on resources, each uniquely identified by a corresponding URI. Resources are logical entities, information about which is stored on one or more servers that together comprise a domain. URIs are the unique names for resources. A resource about which information is stored on a server that is connected to the Internet has a unique URI that allows that information to be accessed by any client computer also connected to the Internet with proper authorization and privileges. URIs are thus globally unique identifiers, and can be used to specify resources on server computers throughout the world. A resource may be any logical entity, including people, digitally encoded documents, organizations, and other such entities that can be described and characterized by digitally encoded information. A resource is thus a logical entity. Digitally encoded information that describes the resource and that can be accessed by a client computer from a server computer is referred to as a “representation” of the corresponding resource. As one example, when a resource is a web page, the representation of the resource may be a hypertext markup language (“HTML”) encoding of the resource. As another example, when the resource is an employee of a company, the representation of the resource may be one or more records, each containing one or more fields, that store information characterizing the employee, such as the employee's name, address, phone number, job title, employment history, and other such information.

In the example shown in FIG. 10, the web servers 1004 provides a RESTful API based on the HTTP protocol 1006 and a hierarchically organized set of resources 1008 that allow clients of the service to access information about the customers and orders placed by customers of the Acme Company. This service may be provided by the Acme Company itself or by a third-party information provider. All of the customer and order information is collectively represented by a customer information resource 1010 associated with the URI “http://www.acme.com/customerInfo” 1012. As discussed further, below, this single URI and the HTTP protocol together provide sufficient information for a remote client computer to access any of the particular types of customer and order information stored and distributed by the service 1004. A customer information resource 1010 represents a large number of subordinate resources. These subordinate resources include, for each of the customers of the Acme Company, a customer resource, such as customer resource 1014. All of the customer resources 1014-1018 are collectively named or specified by the single URI “http://www.acme.com/customerInfo/customers” 1020. Individual customer resources, such as customer resource 1014, are associated with customer-identifier numbers and are each separately addressable by customer-resource-specific URIs, such as URI “http://www.acme.com/customerInfo/customers/361” 1022 which includes the customer identifier “361” for the customer represented by customer resource 1014. Each customer may be logically associated with one or more orders. For example, the customer represented by customer resource 1014 is associated with three different orders 1024-1026, each represented by an order resource. All of the orders are collectively specified or named by a single URI “http://www.acme.com/customerInfo/orders” 1036. All of the orders associated with the customer represented by resource 1014, orders represented by order resources 1024-1026, can be collectively specified by the URI “http://www.acme.com/customerInfo/customers/361/orders” 1038. A particular order, such as the order represented by order resource 1024, may be specified by a unique URI associated with that order, such as URI “http://www.acme.com/customerInfo/customers/361/orders/1” 1040, where the final “1” is an order number that specifies a particular order within the set of orders corresponding to the particular customer identified by the customer identifier “361.”

In one sense, the URIs bear similarity to path names to files in file directories provided by computer operating systems. However, it should be appreciated that resources, unlike files, are logical entities rather than physical entities, such as the set of stored bytes that together compose a file within a computer system. When a file is accessed through a path name, a copy of a sequence of bytes that are stored in a memory or mass-storage device as a portion of that file are transferred to an accessing entity. By contrast, when a resource is accessed through a URI, a server computer returns a digitally encoded representation of the resource, rather than a copy of the resource. For example, when the resource is a human being, the service accessed via a URI specifying the human being may return alphanumeric encodings of various characteristics of the human being, a digitally encoded photograph or photographs, and other such information. Unlike the case of a file accessed through a path name, the representation of a resource is not a copy of the resource, but is instead some type of digitally encoded information with respect to the resource.

In the example RESTful API illustrated in FIG. 10, a client computer can use the verbs, or operations, of the HTTP protocol and the top-level URI 1012 to navigate the entire hierarchy of resources 1008 in order to obtain information about particular customers and about the orders that have been placed by particular customers.

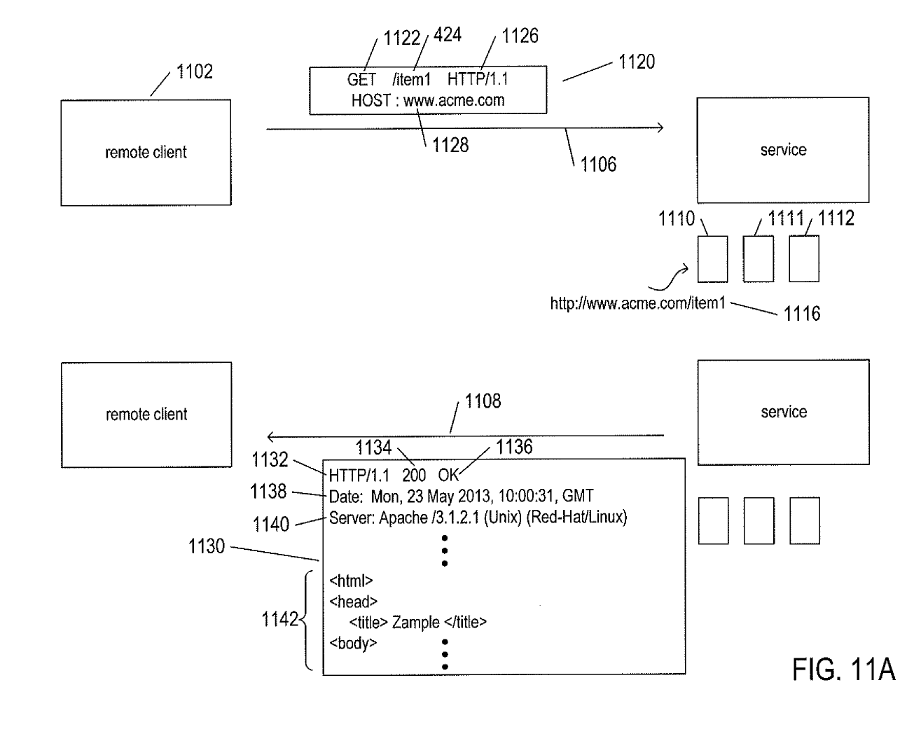

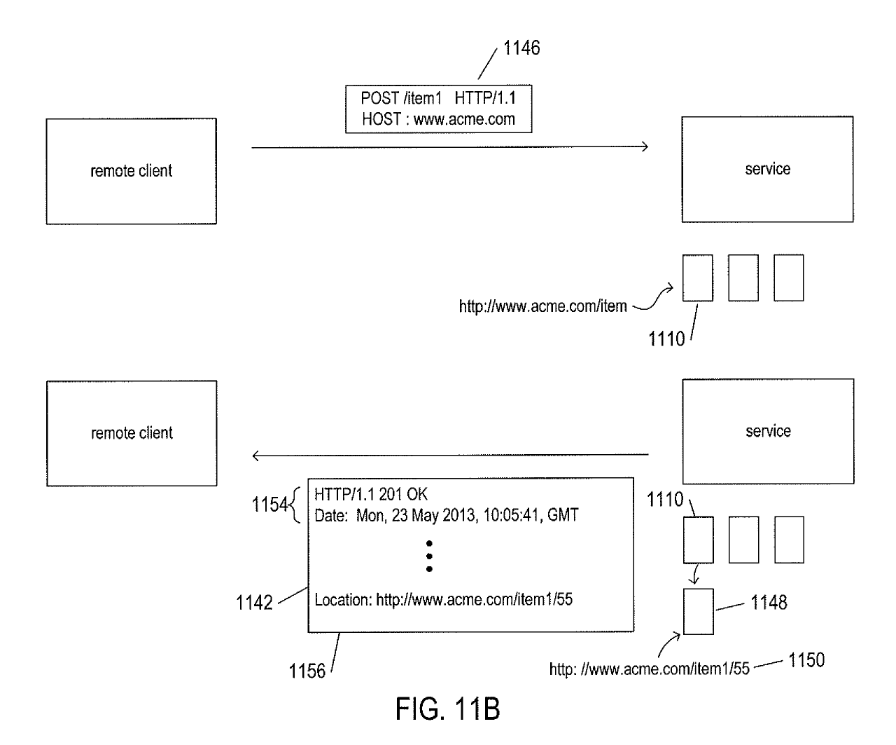

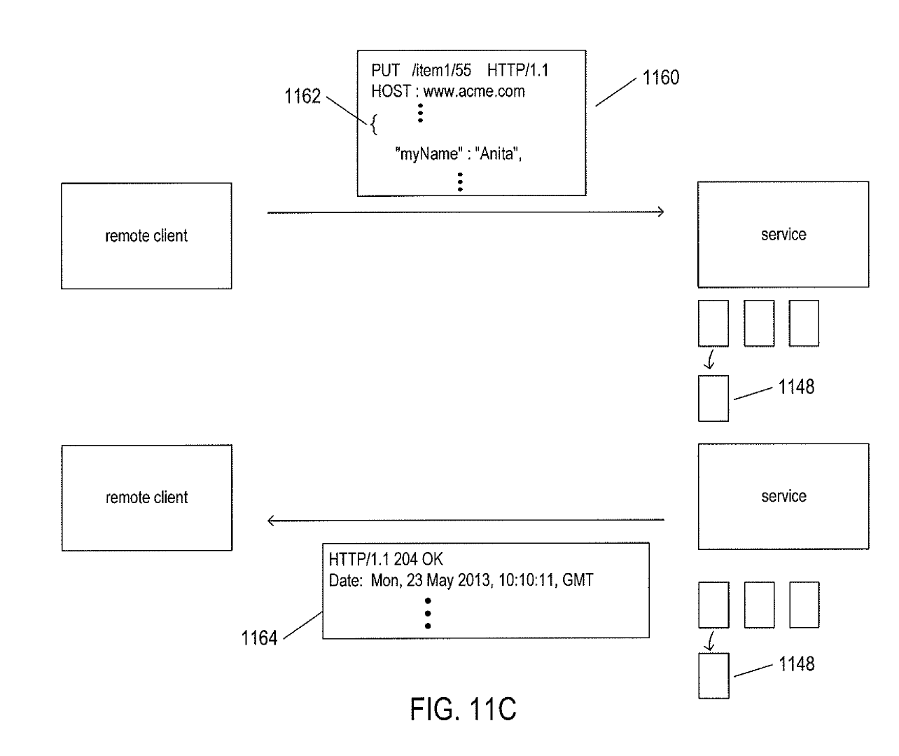

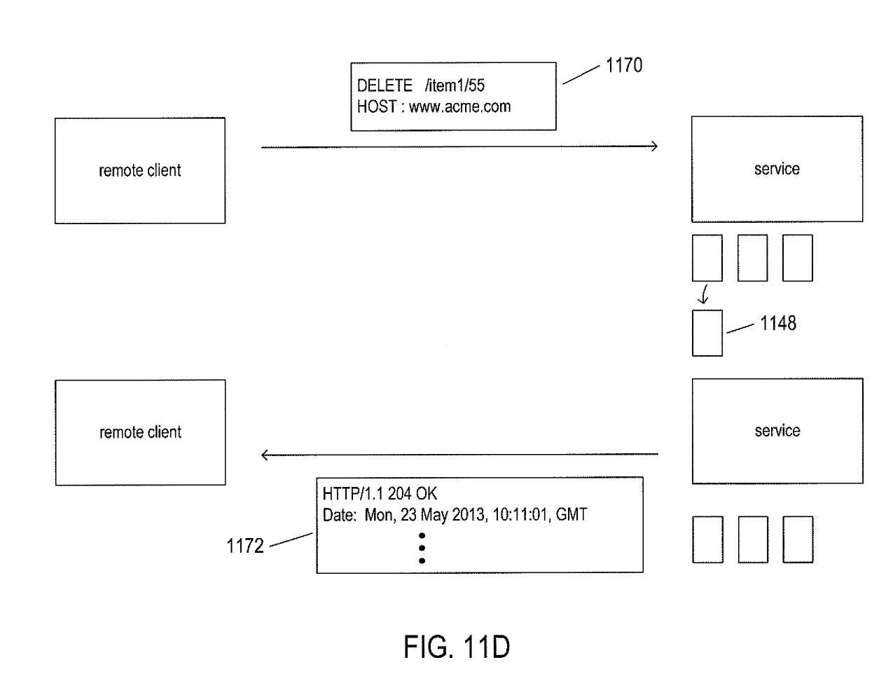

FIGS. 11A-D illustrate four basic verbs, or operations, provided by the HTTP application-layer protocol used in RESTful applications. RESTful applications are client/server protocols in which a client issues an HTTP request message to a service or server and the service or server responds by returning a corresponding HTTP response message. FIGS. 11A-D use the illustration conventions discussed above with reference to FIG. 10 with regard to the client, service, and HTTP protocol. For simplicity and clarity of illustration, in each of these figures, a top portion illustrates the request and a lower portion illustrates the response. The remote client 1102 and service 1104 are shown as labeled rectangles, as in FIG. 10. A right-pointing solid arrow 1106 represents sending of an HTTP request message from a remote client to the service and a left-pointing solid arrow 1108 represents sending of a response message corresponding to the request message by the service to the remote client. For clarity and simplicity of illustration, the service 1104 is shown associated with a few resources 1110-1112.

FIG. 11A illustrates the GET request and a typical response. The GET request requests the representation of a resource identified by a URI from a service. In the example shown in FIG. 11A, the resource 1110 is uniquely identified by the URI “http://www.acme.com/item1” 1116. The initial substring “http://www.acme.com” is a domain name that identifies the service. Thus, URI 1116 can be thought of as specifying the resource “item1” that is located within and managed by the domain “www.acme.com.” The GET request 1120 includes the command “GET” 1122, a relative resource identifier 1124 that, when appended to the domain name, generates the URI that uniquely identifies the resource, and in an indication of the particular underlying application-layer protocol 1126. A request message may include one or more headers, or key/value pairs, such as the host header 1128 “Host:www.acme.com” that indicates the domain to which the request is directed. There are many different headers that may be included. In addition, a request message may also include a request-message body. The body may be encoded in any of various different self-describing encoding languages, often JSON, XML, or HTML. In the current example, there is no request-message body. The service receives the request message containing the GET command, processes the message, and returns a corresponding response message 1130. The response message includes an indication of the application-layer protocol 1132, a numeric status 1134, a textural status 1136, various headers 1138 and 1140, and, in the current example, a body 1142 that includes the HTML encoding of a web page. Again, however, the body may contain any of many different types of information, such as a JSON object that encodes a personnel file, customer description, or order description. GET is the most fundamental and generally most often used verb, or function, of the HTTP protocol.

FIG. 11B illustrates the POST HTTP verb. In FIG. 11B, the client sends a POST request 1146 to the service that is associated with the URI “http://www.acme.com/item1.” In many RESTful APIs, a POST request message requests that the service create a new resource subordinate to the URI associated with the POST request and provide a name and corresponding URI for the newly created resource. Thus, as shown in FIG. 11B, the service creates a new resource 1148 subordinate to resource 1110 specified by URI “http://www.acme.com/item1,” and assigns an identifier “36” to this new resource, creating for the new resource the unique URI “http://www.acme.com/item1/36” 1150. The service then transmits a response message 1152 corresponding to the POST request back to the remote client. In addition to the application-layer protocol, status, and headers 1154, the response message includes a location header 1156 with the URI of the newly created resource. According to the HTTP protocol, the POST verb may also be used to update existing resources by including a body with update information. However, RESTful APIs generally use POST for creation of new resources when the names for the new resources are determined by the service. The POST request 1146 may include a body containing a representation or partial representation of the resource that may be incorporated into stored information for the resource by the service.

FIG. 11C illustrates the PUT HTTP verb. In RESTful APIs, the PUT HTTP verb is generally used for updating existing resources or for creating new resources when the name for the new resources is determined by the client, rather than the service. In the example shown in FIG. 11C, the remote client issues a PUT HTTP request 1160 with respect to the URI “http://www.acme.com/item1/36” that names the newly created resource 1148. The PUT request message includes a body with a JSON encoding of a representation or partial representation of the resource 1162. In response to receiving this request, the service updates resource 1148 to include the information 1162 transmitted in the PUT request and then returns a response corresponding to the PUT request 1164 to the remote client.

FIG. 11D illustrates the DELETE HTTP verb. In the example shown in FIG. 11D, the remote client transmits a DELETE HTTP request 1170 with respect to URI “http://www.acme.com/item1/36” that uniquely specifies newly created resource 1148 to the service. In response, the service deletes the resource associated with the URL and returns a response message 1172.

As further discussed below, and as mentioned above, a service may return, in response messages, various different links, or URIs, in addition to a resource representation. These links may indicate, to the client, additional resources related in various different ways to the resource specified by the URI associated with the corresponding request message. As one example, when the information returned to a client in response to a request is too large for a single HTTP response message, it may be divided into pages, with the first page returned along with additional links, or URIs, that allow the client to retrieve the remaining pages using additional GET requests. As another example, in response to an initial GET request for the customer info resource (1010 in FIG. 10), the service may provide URIs 1020 and 1036 in addition to a requested representation to the client, using which the client may begin to traverse the hierarchical resource organization in subsequent GET requests.

Scientific-Workflow System to which the Current Document is Directed

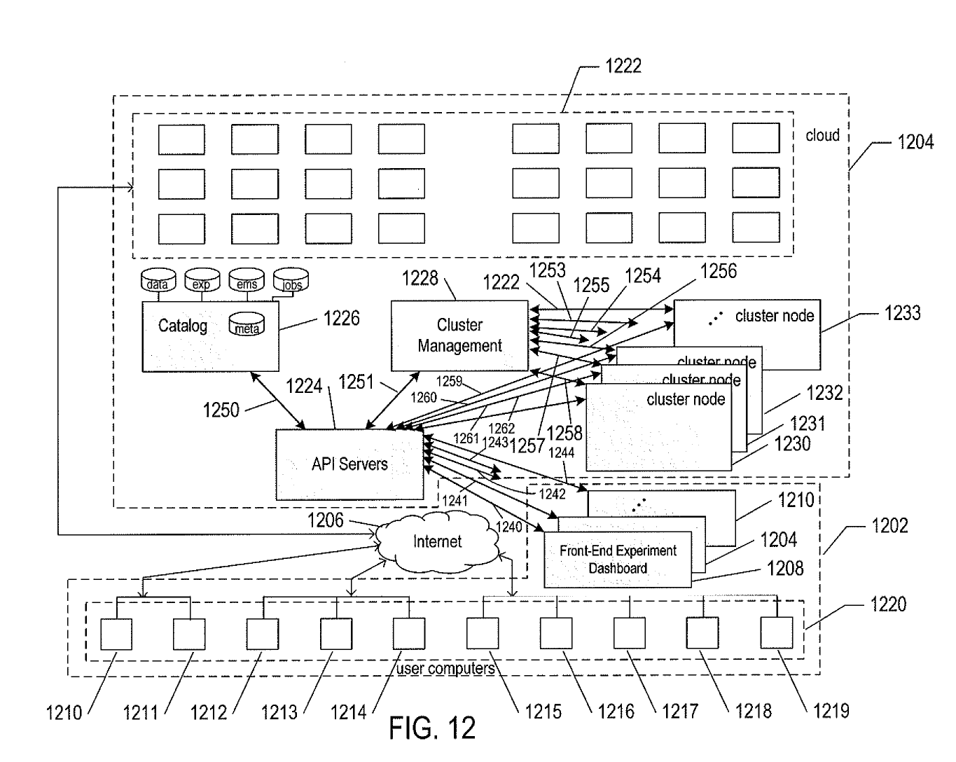

FIG. 12 illustrates the main components of the scientific-workflow system to which the current document is directed. The scientific-workflow system includes a front end 1202 and a back end 1204. The front end is connected to the back end via the Internet 1206 and/or various types and combinations of personal area networks, local area networks, wide area networks, and communications sub-systems, systems, and media. The front-end portion of the scientific-workflow system includes generally multiple front-end experiment dashboard applications 1208-1210 that each runs on a user computer or other processor-controlled user device. Each front-end experiment dashboard provides a user interface to a human user that allows the human user to download information about execution modules, data sets, and experiments stored in the back-end portion of the scientific-workflow system 1204, create and edit experiments using directed-acyclic-graph—(“DAG”) based visualizations, submit experiments for execution, view results generated by executed experiments, upload data sets and execution modules to the scientific-workflow-system back end, and share experiments, execution modules, and data sets with other users. In essence, the front-end experiment-dashboard applications provide a kind of interactive development environment and window or portal into the scientific-workflow system and, through the scientific-workflow system, to a community of scientific-workflow-system users. In FIG. 12, the outer dashed rectangle 1202 represents the scientific-workflow-system front end while the inner dashed rectangle 1220 represents the hardware platform that supports the scientific-workflow-system front end. The shaded components 1208-1210 within the outer dashed rectangle 1202 and external to the inner dashed rectangle 1220 represent components of the scientific-workflow system implemented within the hardware platform 1220. A similar illustration convention is used for the scientific-workflow-system back end 1204 that is implemented within one or more cloud-computing systems, centralized or distributed private data centers, or on other generally large-scale multi-computer-system computational environments 1222. These large computational environments generally include multiple server computers, network-attached storage systems, internal networks, and often include main frames or other large computer systems. The scientific-workflow-system back end 1204 includes one or more API servers 1224, a distributed catalog service 1226, a cluster-management service 1228, and multiple execution-cluster nodes 1230-1233. Each of these back-end components may be mapped to multiple physical servers and/or large computer systems. As a result, the back-end portion of the scientific-workflow system 1204 is relatively straightforwardly scaled to provide scientific-workflow services to increasing numbers of users. Communications between the front-end experiment dashboards 1208-1210 and the API servers 1224, represented by double-headed arrows 1240-1244 is based on the previously discussed RESTful communications model, as are the internal communications between back-end components, represented by double-headed arrows 1250-1262. All of the components shown in FIG. 12 within the back end other than the catalog service 1226 are stateless and exchange information through stateless RESTful protocols.

The API servers 1224 receive requests from, and send responses to, the front-end experiment-dashboard applications running on user computers. The API servers carry out requests by accessing services provided by the catalog service 1226 and cluster-management service 1228. In addition, the API servers provide services to the execution cluster nodes 1230-1233 and cluster-management service 1228. The catalog service 1226 provides an interface to stored execution modules, experiments, data sets, and jobs. In many implementations, the catalog service 1226 locally stores metadata for these different entities that allows the entities themselves to be accessed from, and stored on, remote or attached storage systems, including network-attached storage appliances, database systems, file systems, and other such data-storage systems. The catalog service 1226 is a repository for state information associated with previously executed, currently executing, and future executing jobs. Jobs are execution instances of execution modules. The catalog service 1226 provides versioning of, and a search interface to, the stored data-set, experiment, execution-module, and job entities.

The cluster-management service 1228 receives, from the API servers, job identifiers for jobs that need to be executed on the execution cluster nodes in order to carry out experiments on behalf of users. The cluster-management service dispatches the jobs to appropriate execution cluster nodes for execution. Jobs are that ready for execution are forwarded to particular execution cluster nodes for immediate execution while jobs that need to wait for data produced by currently executing jobs or jobs waiting for execution are forwarded to pinger routines executing within execution cluster nodes that intermittently check for satisfaction of dependencies in order to launch jobs when their dependencies have been satisfied. When jobs have finished execution, output data and status information is returned from execution cluster nodes via the API servers to the catalog.

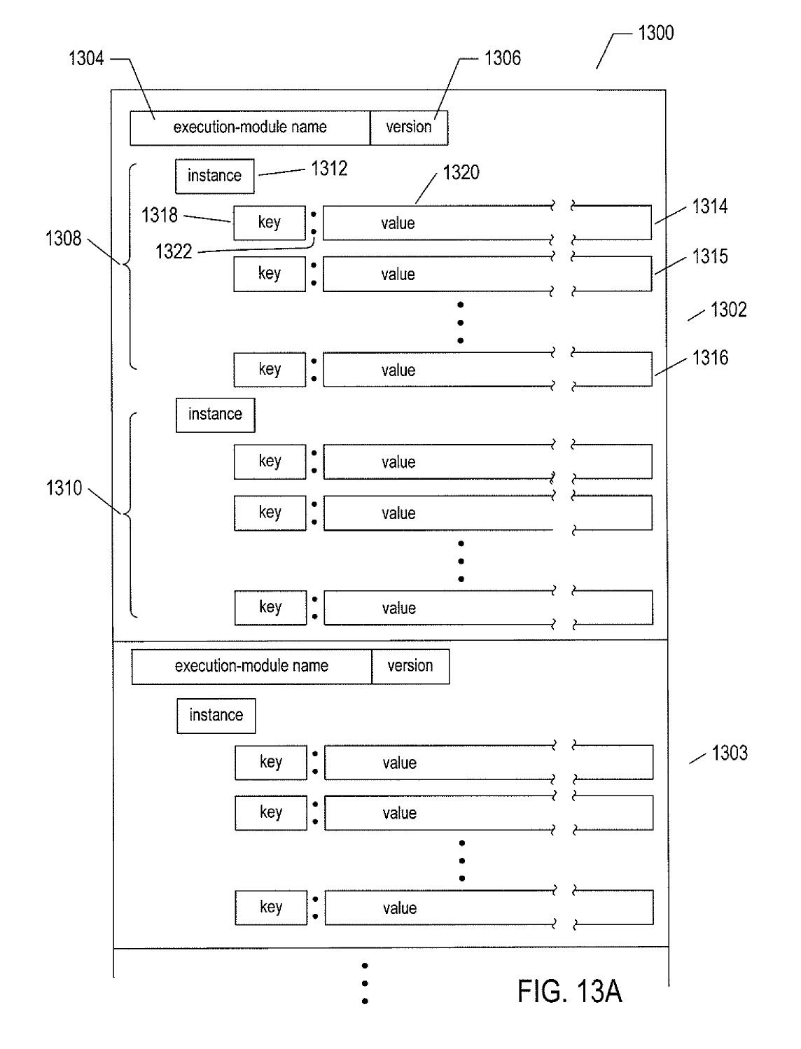

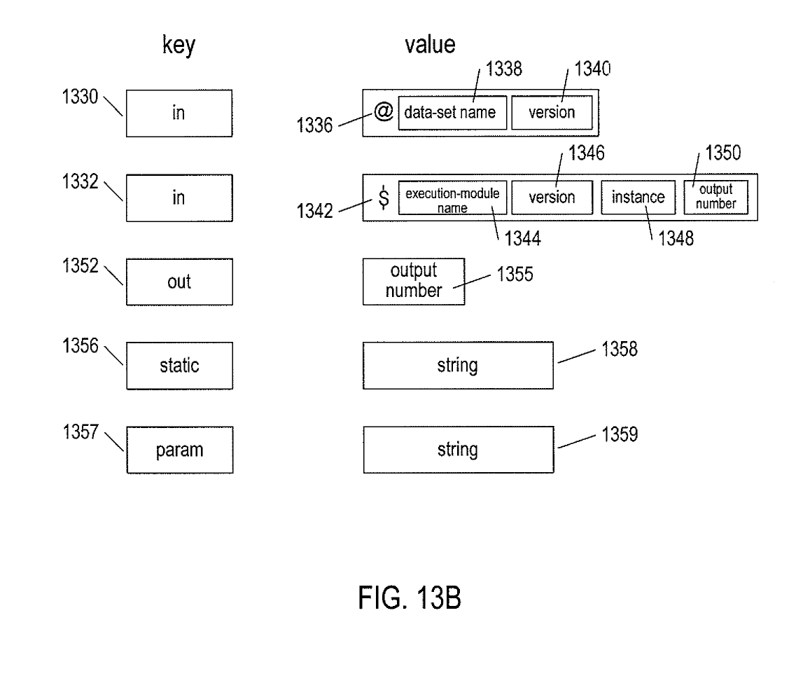

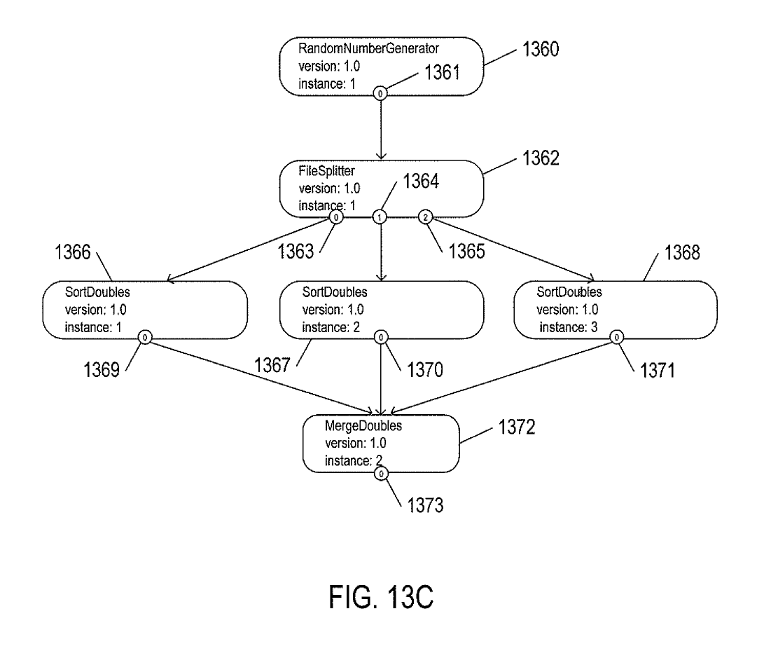

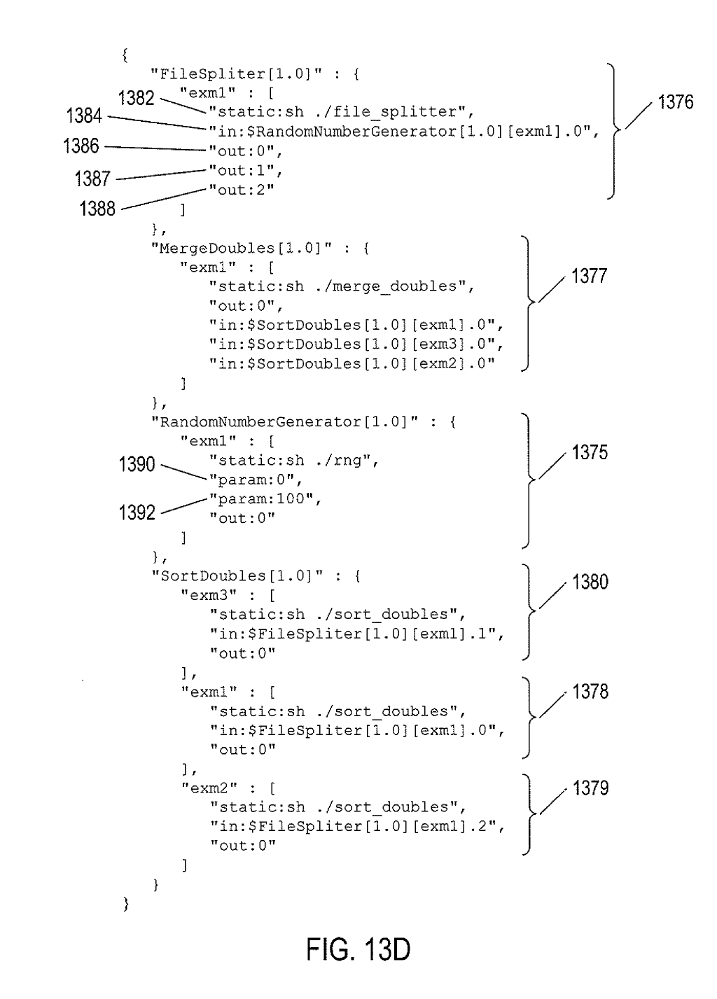

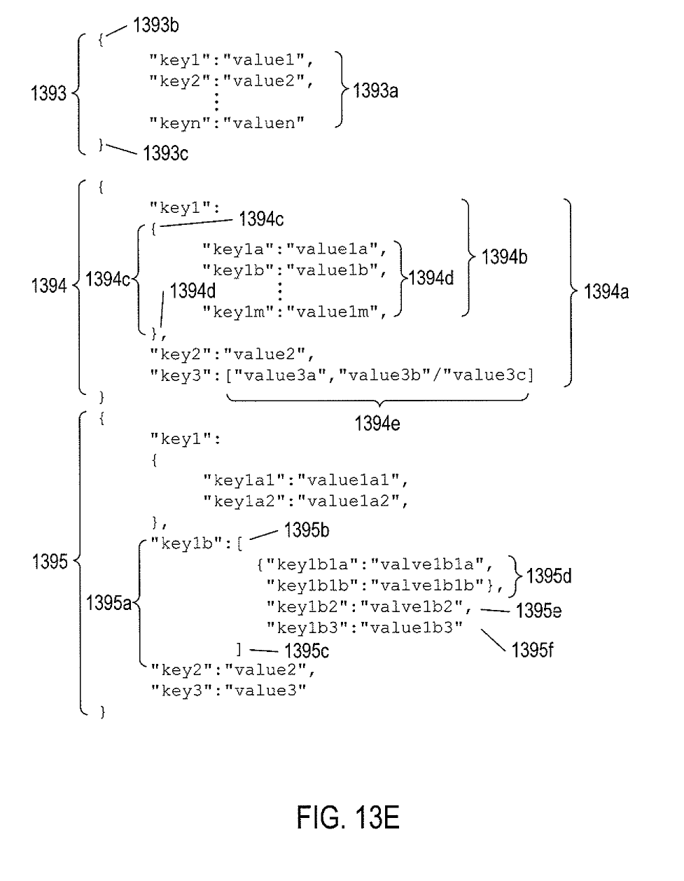

As discussed above, experiments are represented visually via the front-end experiment dashboard as DAGs that include data-source and execution-module nodes. In one implementation of the scientific-workflow system, experiment DAGs are textually encoded in the JavaScript object notation (“BON”). An experiment DAG is textually encoded as a list of JSON-execution modules. FIGS. 13A-E illustrate the JSON encoding of a relatively simple six-node experiment DAG. In FIG. 13A, a block-diagram-like illustration of the JSON-encoded experiment DAG is provided. The JSON-encoded experiment DAG consists of a list 1300 of JSON-encoded execution modules 1302 and 1303. The JSON encoding of an execution module 1302 includes an execution-module name 1304 and version number 1306 and encodings for each of one or more execution-module instances 1308 and 1310. Each execution-module instance includes an instance name or identifier 1312 and a list or set of key-value pairs 1314-1316, each key-value pair including a textually represented key 1318 separated from a textually represented value 1320 by a colon 1322.

An execution module is an executable that can be executed by an execution cluster node. The scientific-workflow system can store and execute executables compiled from any of many different programming languages. Execution modules may be routines or multi-routine programs. An execution-module instance is mapped to a single node of an experiment DAG. When the same execution module is invoked multiple times during an experiment, each invocation corresponds to a different instance. The key-value pairs 1314-1316 provide indications of the data inputs to the execution module, data outputs from the execution module, static parameters, and variable parameters for the execution module. FIG. 13B illustrates different types of key-value pairs that may occur within the list or set of key-value pairs in the JSON encoding of an instance within an execution module. There are two types of input key-value pairs 1330 and 1332 in FIG. 13B. Both types of input key-value pairs include the key “in” 1334. The first input key-value pair 1330 includes a value string comprising an “at” symbol 1336, the name of a data set 1338, and a version number 1340. This first type of input key-value pair specifies a named data set stored in the catalog service (1226 in FIG. 12) of the scientific-workflow-system back end (1204 in FIG. 12). The second input key-value pair type 1332 specifies data output from an execution-module instance to the execution-module instance that includes the input key-value pair. The second input key-value pair type 1332 a value string that begins with a dollar sign 1342 that is followed by an execution-module name 1344, a version number for the execution module 1346, an instance name or identifier for an instance of the execution module 1348, and an output number 1350 that indicates which output of the execution module produces the data to be input to the instance of the execution module containing the input key-value pair.

All of the data outputs from an instance of an execution module are specified by an output key-value pair 1352. The key for an output key-value pair is “out” 1354 and the value is an integer output number 1355. Command-line static parameters and variable parameters are represented by static key-value pairs 1356 and param key-value pairs 1357. Both static and param key-value pairs include string values 1358 and 1359.

FIG. 13C shows a relatively simple experiment DAG visually represented by nodes and links. A single instance of a random-number-generator executable module 1360 generates data via a single output 1361 to a file-splitter executable-module instance 1362. The file-splitter executable-module instance produces three data outputs 1363-1365. These outputs are directed to each of three instances of a double-sorting execution module 1366-1368. The three instances of the double-sorting execution module 1366-1368 each generates an output 1369-1371, and all three of these outputs are input to an instance of a doubles-merging execution module 1372, which produces a single output 1373. FIG. 13D shows the JSON encoding of the experiment DAG shown in FIG. 13C. The single instance of the random-number-generator execution module (1360 in FIG. 13C) is represented by text 1375. The single instance of the file-splitter execution module (1362 in FIG. 13C) is represented by text 1376. The single instance of the doubles-merging execution module (1372 in FIG. 13C) is represented by text 1377. The three instances of the doubles-sorting execution module (1366-1368 in FIG. 13C) are represented by text 1378, 1379, and 1380 in FIG. 13D. Consider the text 1376 from the JSON encoding of the experiment DAG of FIG. 13C that represents the file-splitter execution module in FIG. 13D. The command-line static parameter is represented by the key-value pair 1382. The input of data output from the random-number-generator execution module (1360 in FIG. 13C) is represented by the input key-value pair 1384. The three data outputs from the instance of the file-splitter execution module (1363-1365 in FIG. 13C) are represented by the three output key-value pairs 1386-1388. Two parameters received by the random-number-generator execution module (1360 in FIG. 13C) are specified by the two param key-value pairs 1390 and 1392.

FIG. 13E illustrates three different JSON-encoded objects. FIG. 13E is intended to illustrate certain aspects of JSON used in subsequent figures as well as in FIG. 13D. A first JSON-encoded object 1393 is a list of comma-separated key-value pairs 1393a enclosed within braces 1393b and 1393c. Each key-value pair consists of two strings separated by a colon. A second JSON-encoded object 1394 also includes a list of key-value pairs 1394a. In this case, however, the first key-value pair 1394b includes a value 1394c that is a list of key-value pairs 1394d encoded within braces 1394c and 1394d. Thus, the value of a key-value pair may be a string or may be a JSON-encoded sub-object. Another type of value is a bracket-enclosed list of strings that represents an array of strings 1394e. In the third JSON-encoded object 1395, a second key-value pair 1395a includes an array value enclosed within brackets 1395b and 1395c with elements that include an object 1395d including two key-value pairs as well as two key-value pairs 1395e and 1395f. Thus, JSON is a hierarchical object-or-entity encoding system that allows for an arbitrary number of hierarchical levels. Objects are encoded by JSON as key-value pairs, but the values of a given key-value pair may themselves be sub-objects and arrays.

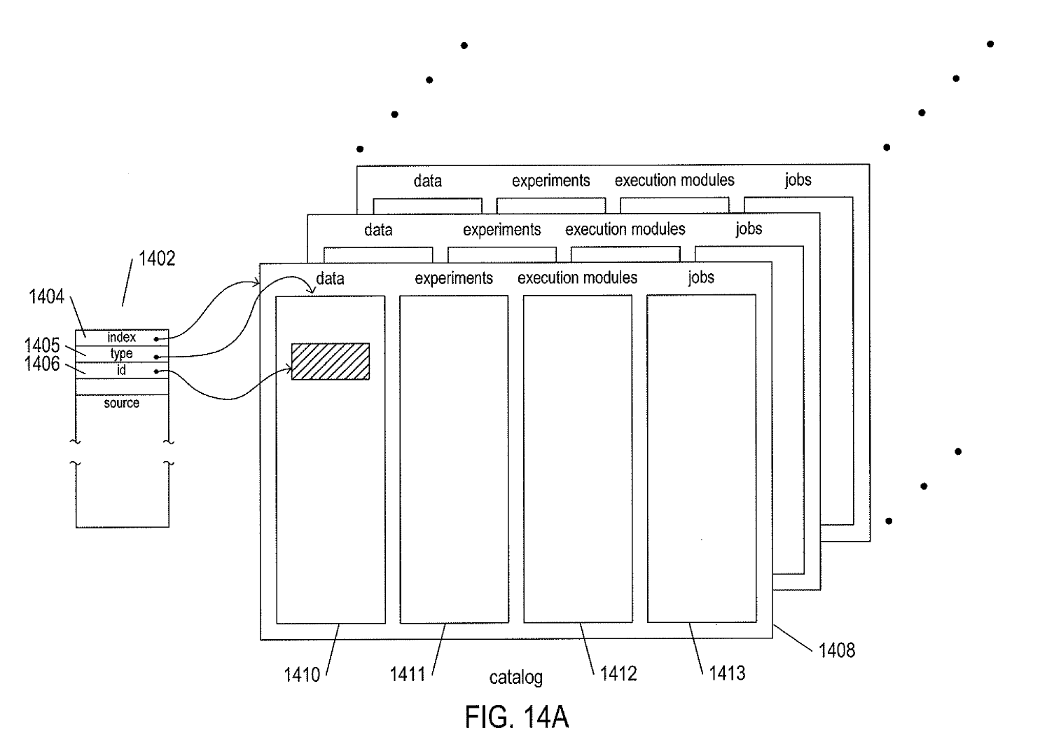

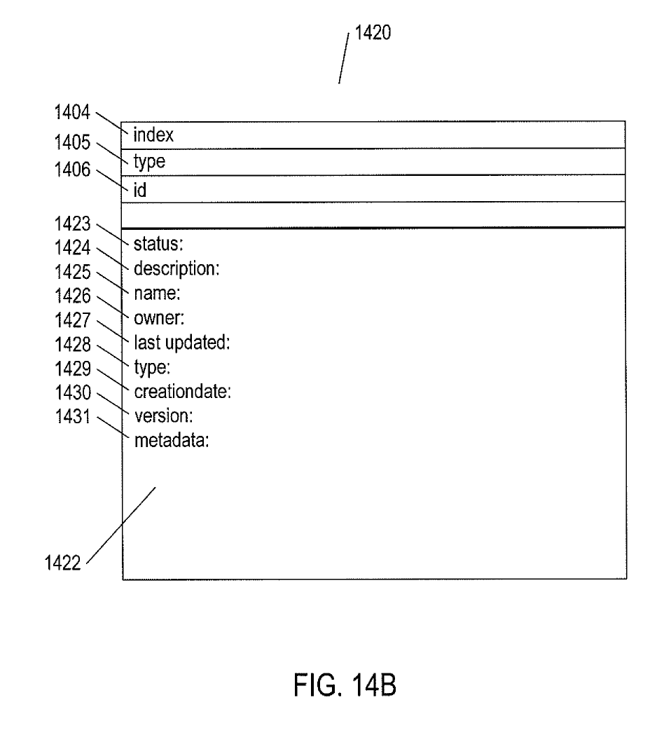

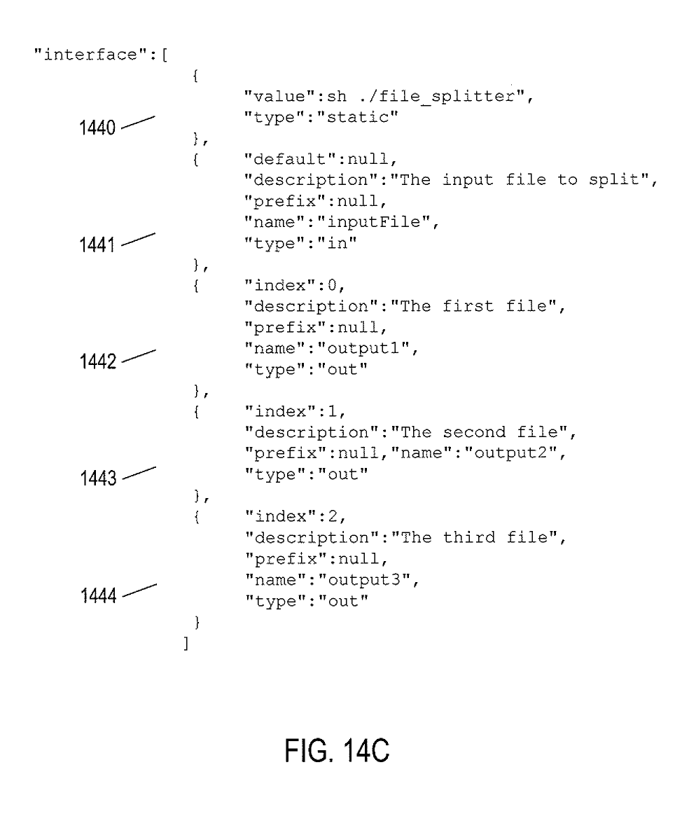

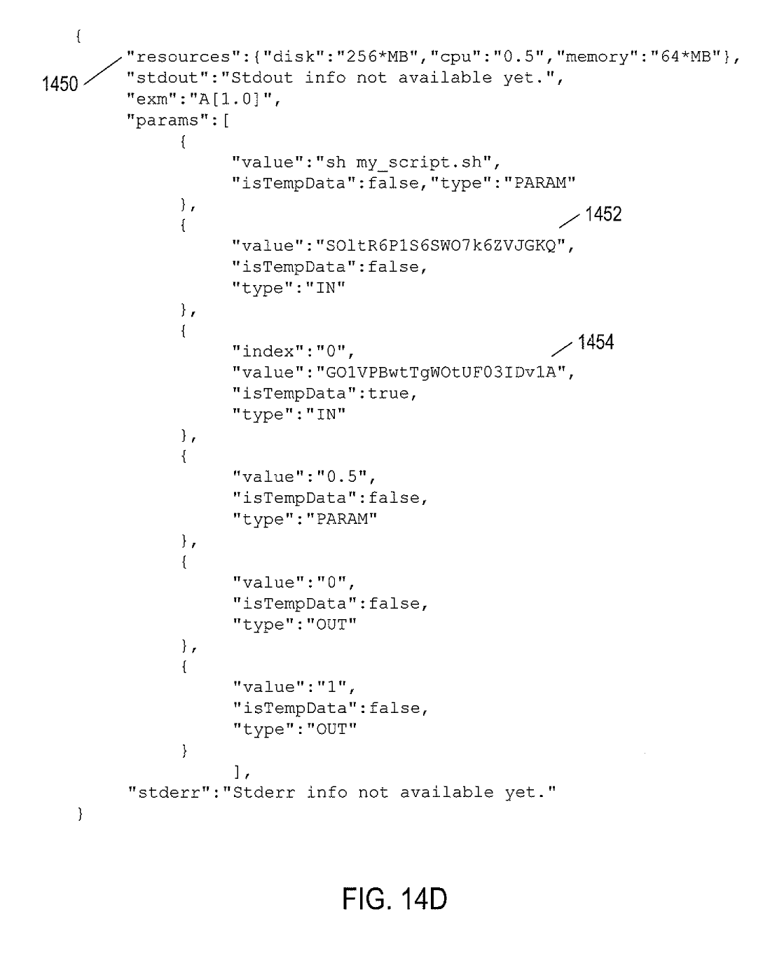

FIGS. 14A-D illustrate the metadata that is stored in the catalog service (1226 in FIG. 12). FIG. 14A illustrates the logical organization of the metadata stored within the catalog service. Each catalog entry 1402 includes an index 1404, a type 1405, and an identifier 1406. There are four different types of catalog entries: (1) data-source entries; (2) experiment entries; (3) execution module entries; and (4) job entries. Data entries describe data sets that are input to jobs during job execution. Data entries describe both named data sets that are uploaded to the scientific-workflow system by users as well as temporary data sets that represent the output from jobs that is input to other jobs that execute within the context of an experiment. For example, the data sources 102 and 104 shown in the experiment DAG of FIG. 1 are named data sources uploaded to, or generated within, the scientific-workflow system in advance of experiment execution. By contrast, outputs from execution-module instances, such as output 116, are stored as temporary data sets by the catalog for subsequent input to execution-module instance 106. Experiments are described by experiment DAGs, discussed above with reference to FIGS. 13A-D. Execution modules are, in part, described by JSON encodings but, in addition, include references to stored executable files or objects that include the actual computer instructions or p-code instructions that are executed as a job during experiment execution. Job entries describe jobs that correspond to execution modules as well as including a job status and identifiers for inputs from upstream, dependent jobs.

The scientific-workflow system may support experiment workflows and experiment execution for many different users and organizations. Thus, as shown in FIG. 14A, for each user or user organization, the catalog may contain data, experiment, execution-module, and job entries for that user or user organization. In FIG. 14A, each large rectangle, such as large rectangle 1408, represents the catalog entries stored on behalf of a particular user or user organization. Within each large rectangle, there are four smaller rectangles, such as smaller rectangles 1410-1413 within larger rectangle 1408, that represent the stored data, experiment, execution-module, and job entries, respectively. The index field of the catalog entry 1404 identifies the particular collection of stored metadata for a particular user or user organization. The type field 1405 of a catalog entry indicates which of the four different types of stored entries the entry belongs to. The ID field 1406 of a stored entry is a unique identifier for the stored entry that can be used to find and retrieve the stored entry from the collection of entries of the same type for a particular user or organization.

FIG. 14B provides greater detail with respect to the contents of a catalog entry. As discussed above with reference to FIG. 14A, each catalog entry 1420 includes an index 1404, type 1405, and ID field 1406. In addition, each entry includes a source section 1422. The source section includes a status value 1423, a short description 1424, a name 1425, an owner 1426, a last-updated date/time 1427, a type 1428, a creation date 1429, a version 1430, and metadata 1431. FIG. 14C shows a portion of the metadata for an execution-module catalog entry that describes the file-splitter execution module that is shown as node 1362 in the experiment DAG shown in FIG. 13C. This node is encoded in text 1376 within the JSON encoding of the experiment shown in FIG. 13D. The portion of the metadata for the execution-module catalog entry for this execution module shown in FIG. 14C is a JSON encoding of the interface for the execution module, which is a description of the key-value pairs 1382-1388 included in the JSON of the file-splitter node 1376 in FIG. 13D for the experiment represented by the experiment DAG shown in FIG. 13C. The interface is an array that includes five objects 1440-1444 corresponding to the key-value pairs 1382-1388 in FIG. 13D. The JSON-encoded object 1441 within the interface array is a description of input parameter 1384, which can be used to incorporate a JSON encoding of an experiment-DAG node into an experiment DAG that represents the execution module described by the execution-module entry that includes the interface encoding shown in FIG. 14C.

FIG. 14D shows a portion of the metadata stored within a job catalog entry. This metadata include a resources key-value pair 1450 that specifies the amount of disk space, CPU bandwidth, and memory needed for execution of the job as well as the values for the various execution-module parameters for the execution module corresponding to the job. Note that, in the metadata shown in FIG. 14D, input parameters corresponding to input from jobs on which the currently described job depends include job identifiers, such as job identifiers 1452 and 1454, rather than references to execution-module instances, as in the JSON encoding of the doubles-merging node (1377 in FIG. 13D) for the experiment DAG shown in FIG. 13C.

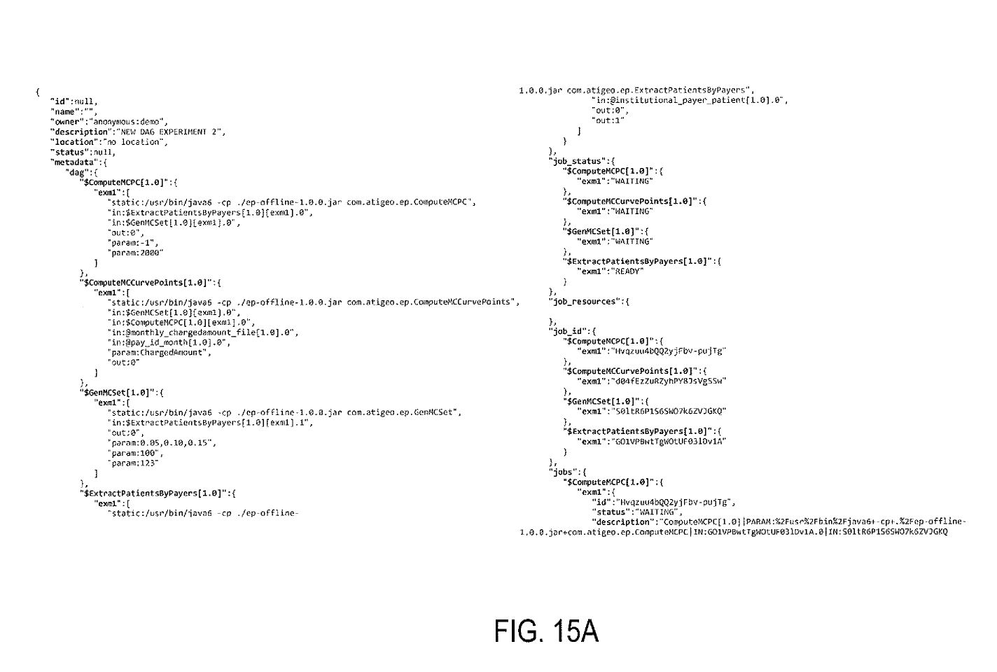

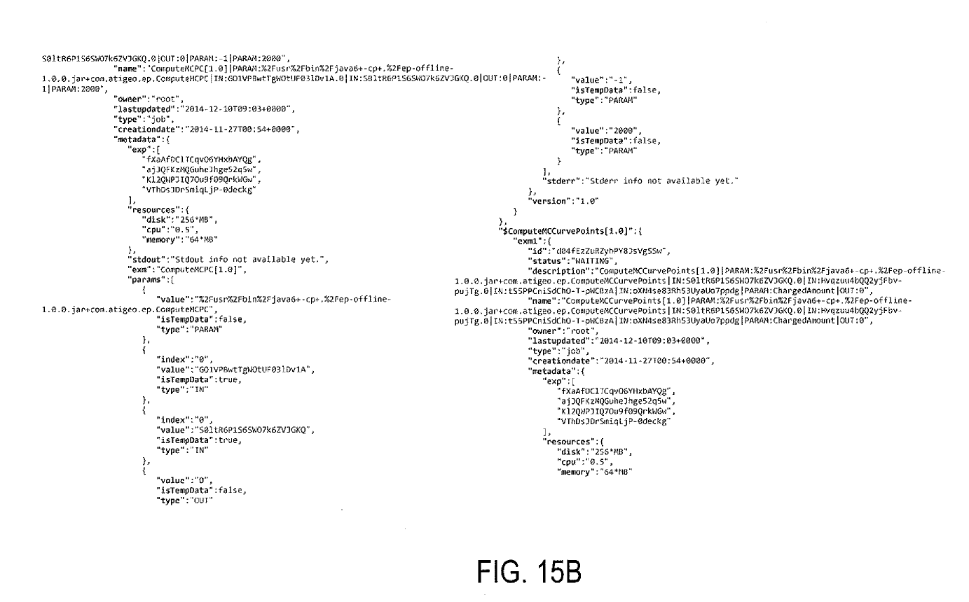

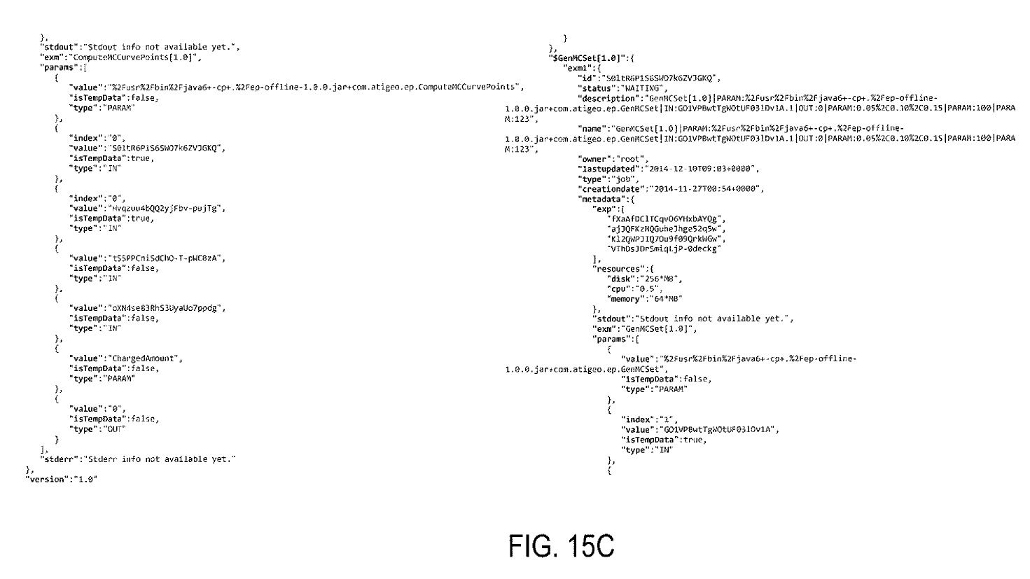

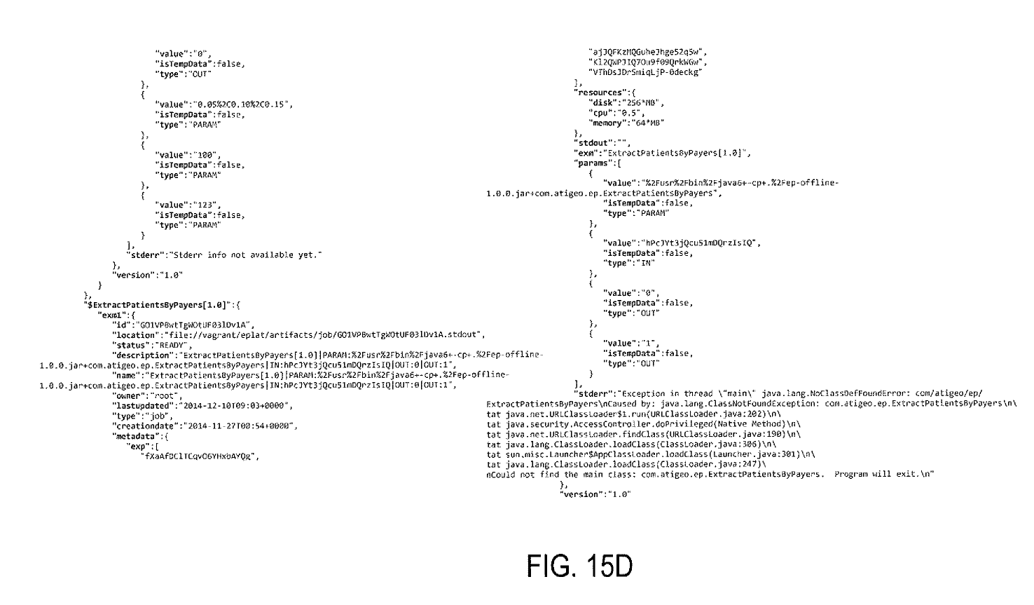

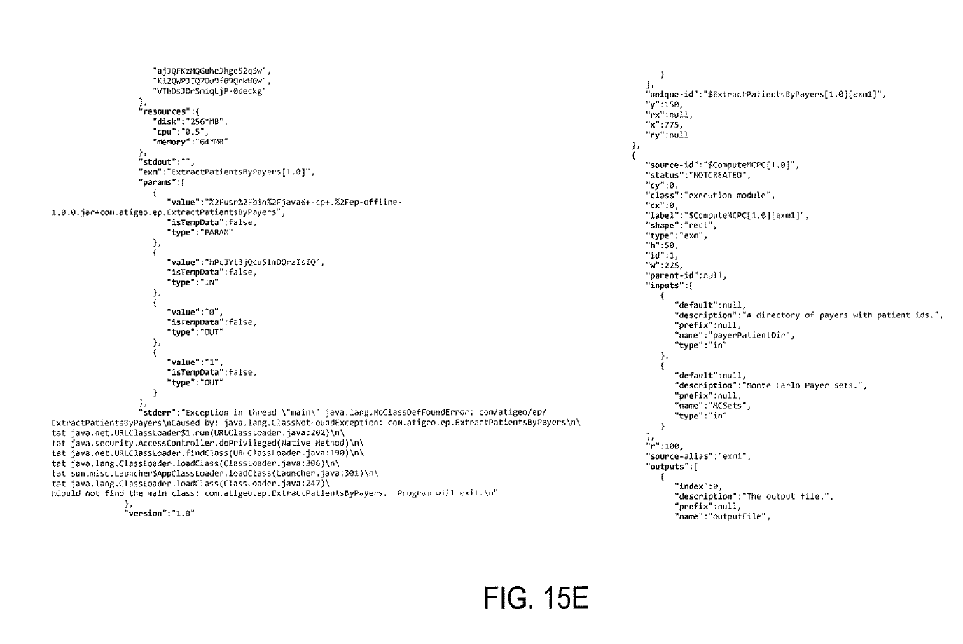

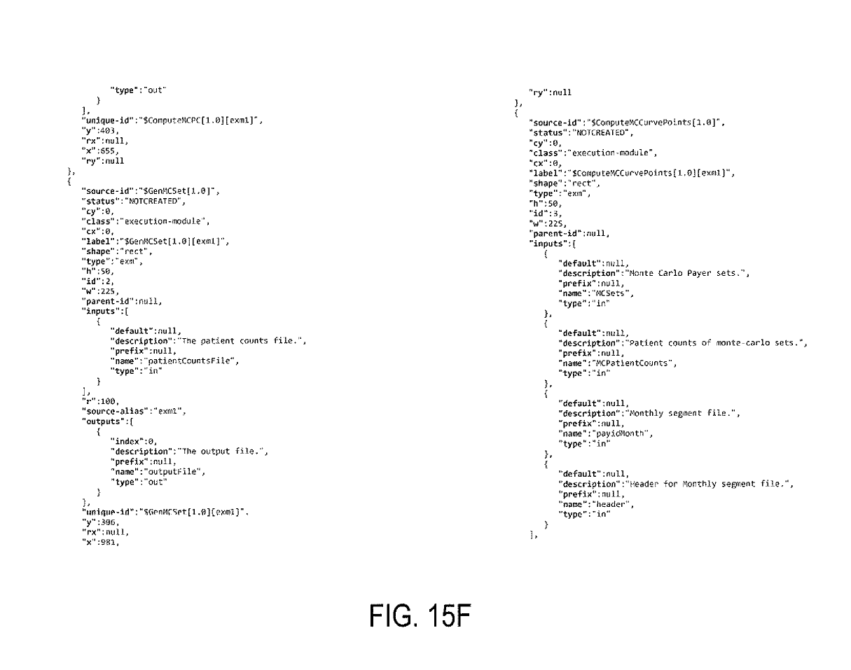

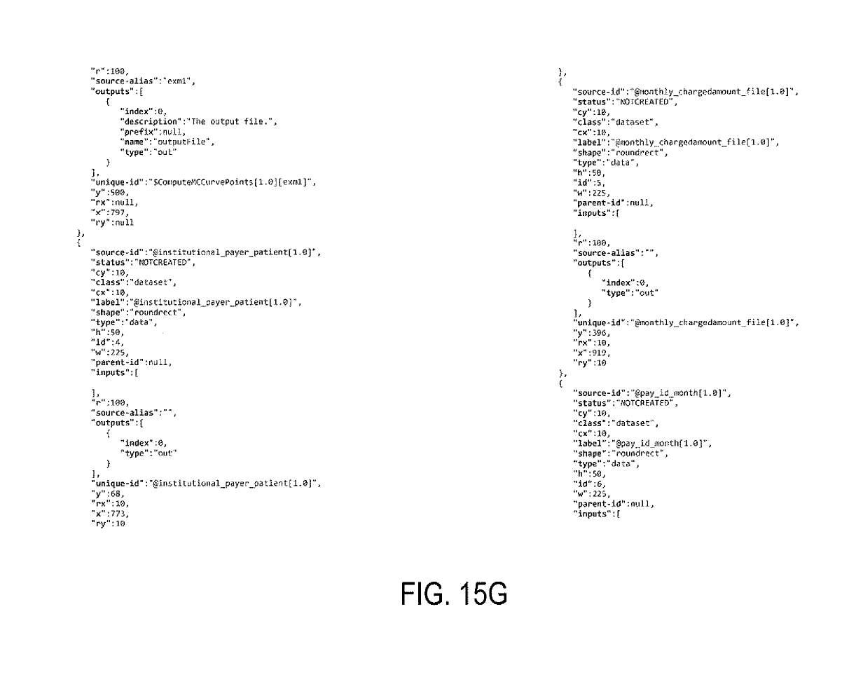

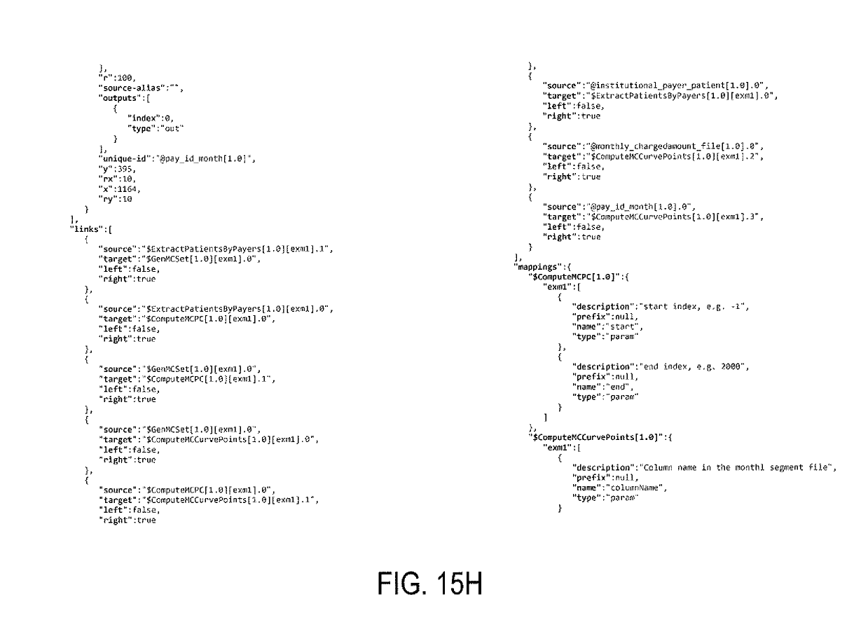

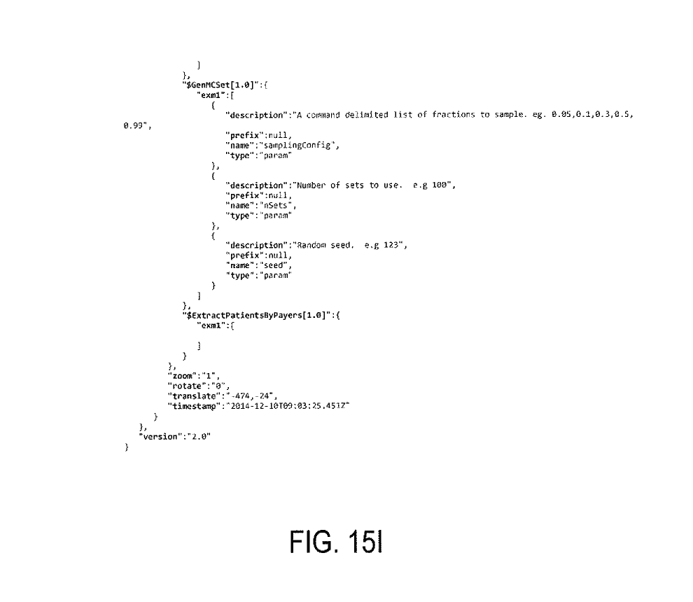

FIGS. 15A-I provide an example of an experiment layout DAG corresponding to an experiment DAG, such as the experiment DAG discussed above with reference to FIGS. 13C-D. The experiment layout DAG shown in FIGS. 15A-I include significant additional information, including a layout section that describes the locations and orientations of the visual-display elements, such as nodes and links, that together comprise the visual representation of the experiment DAG provided to a user through the front-end experiment dashboard. The experiment layout DAG form of an experiment DAG may be used by the front end and API servers, but is generally not used by the cluster-management service and the execution-cluster nodes.

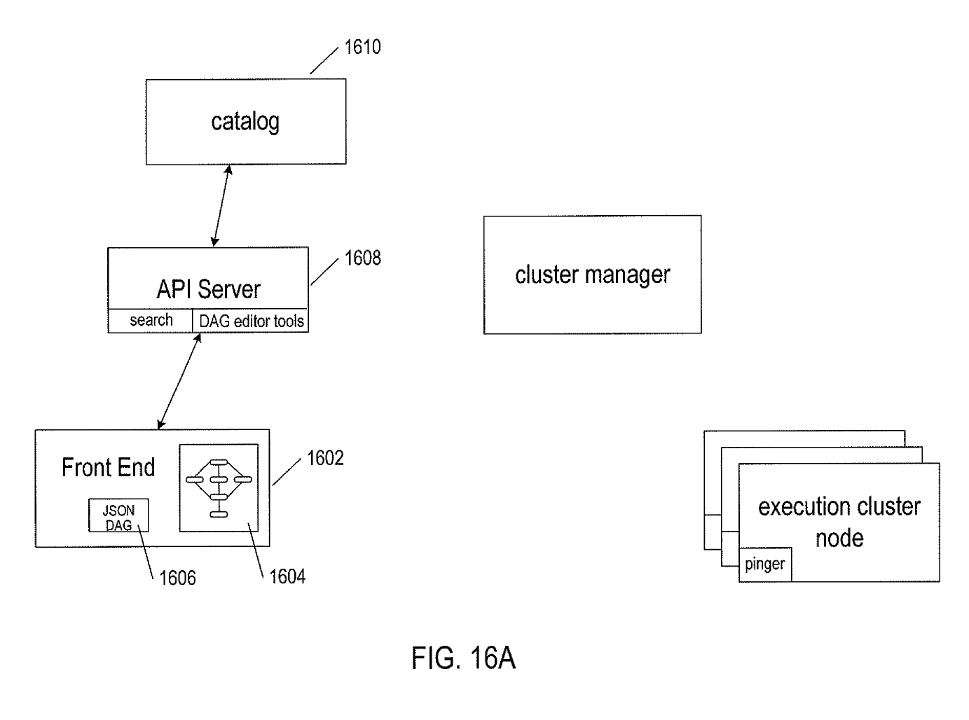

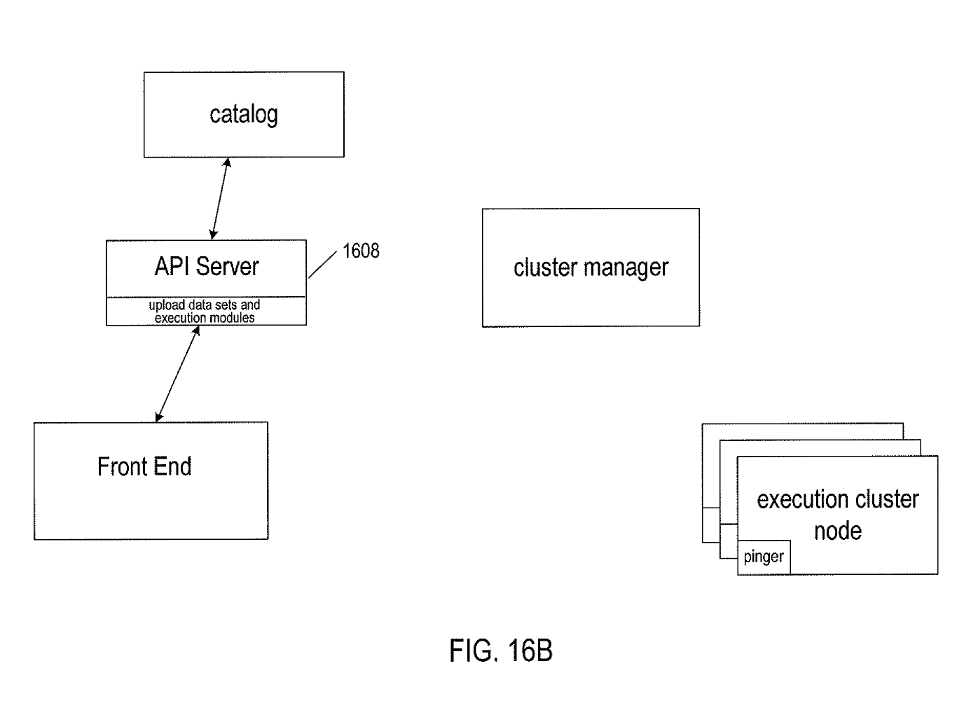

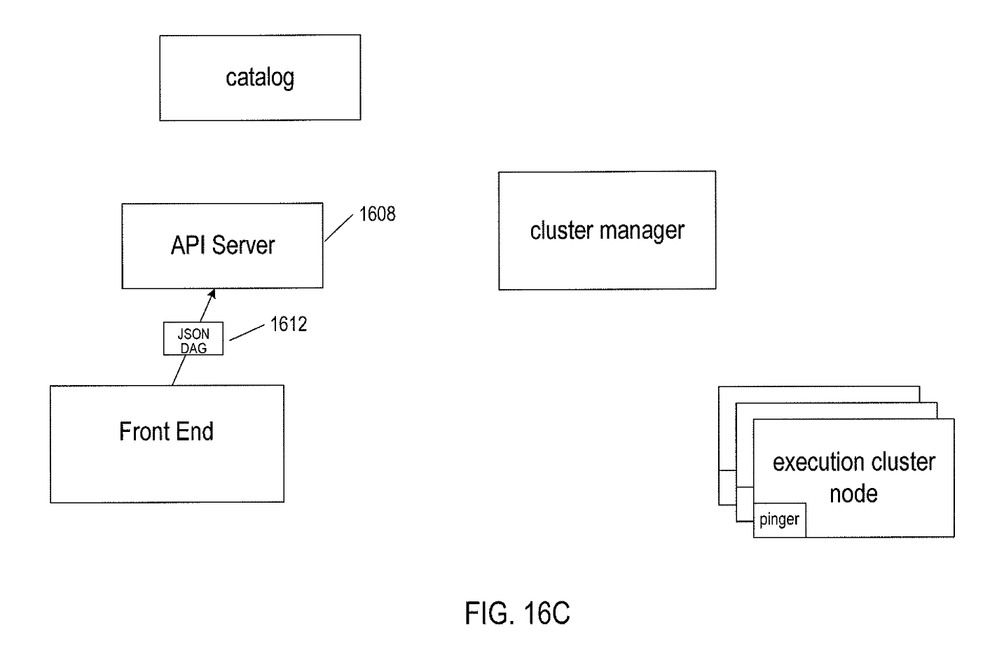

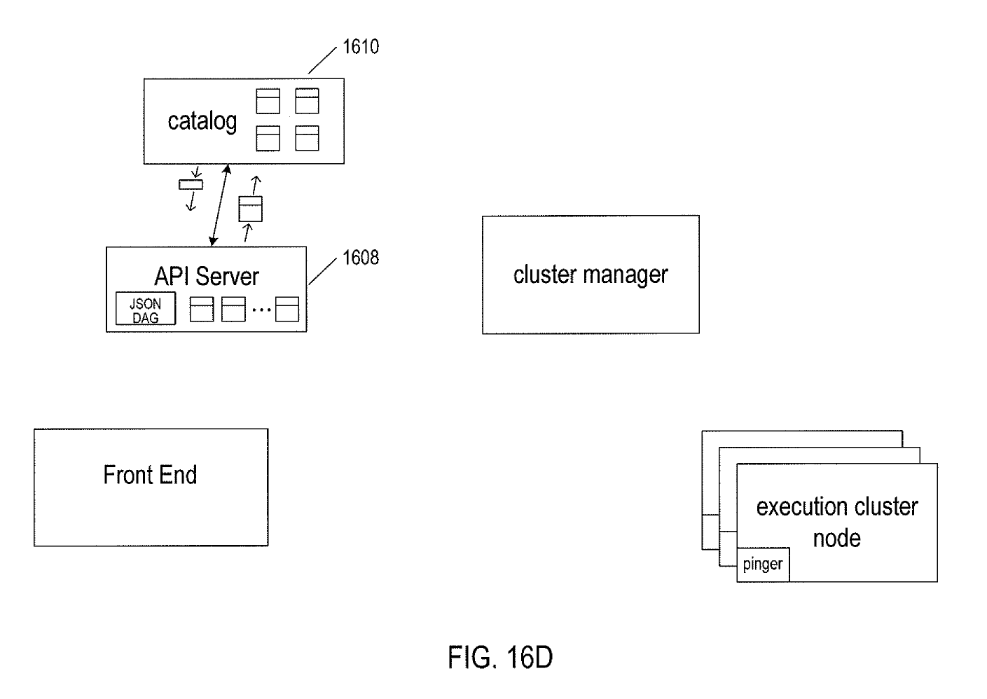

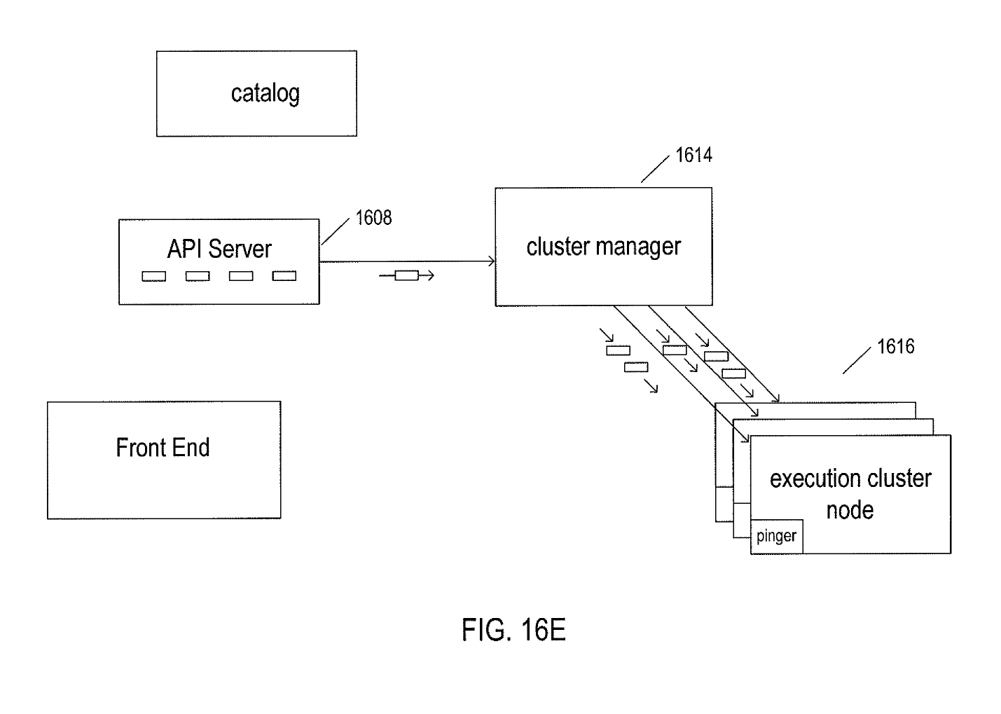

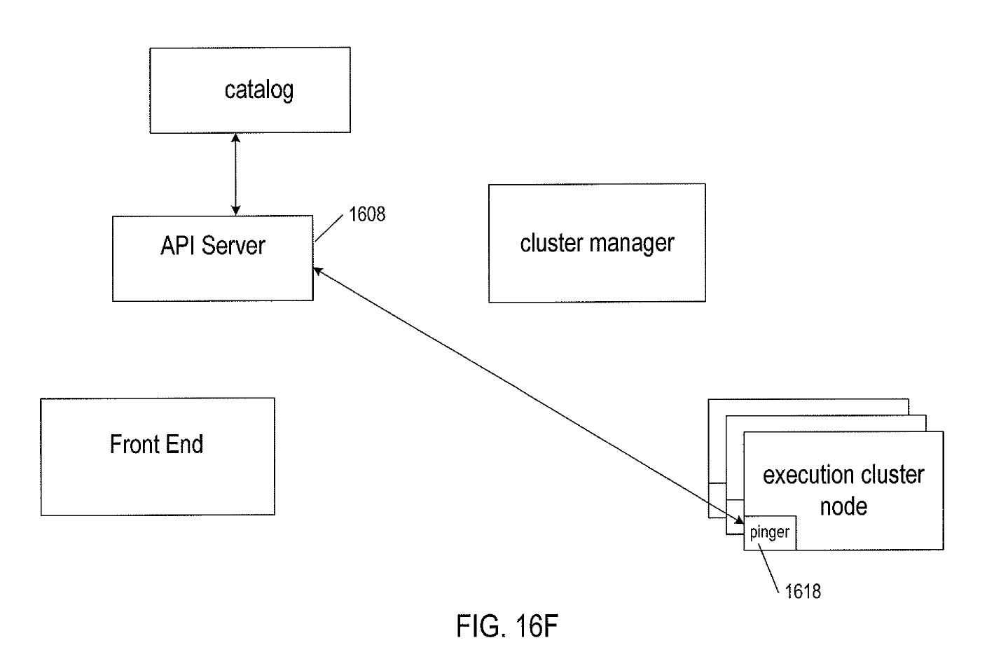

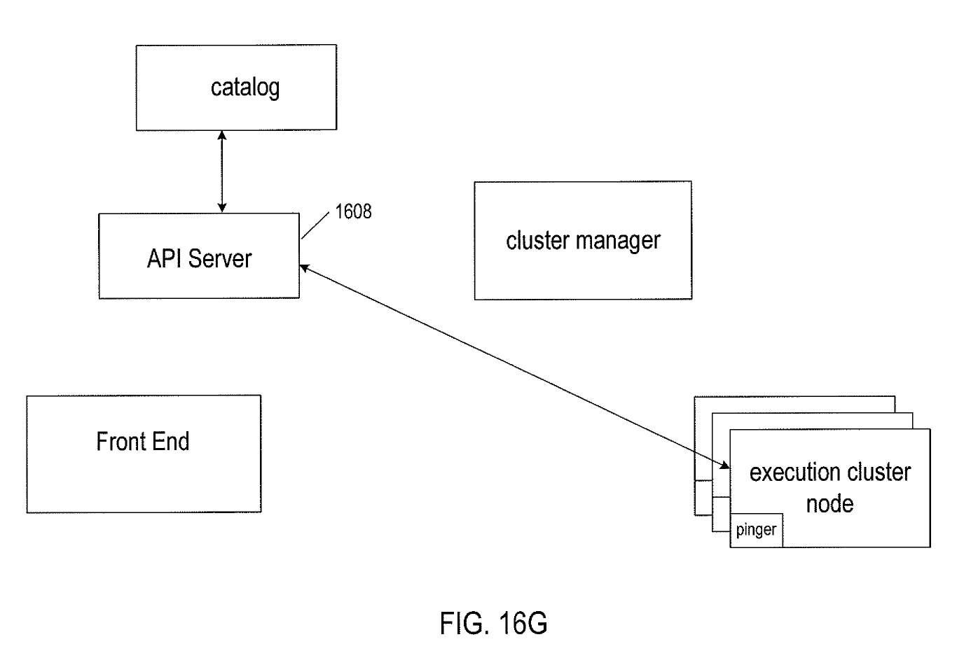

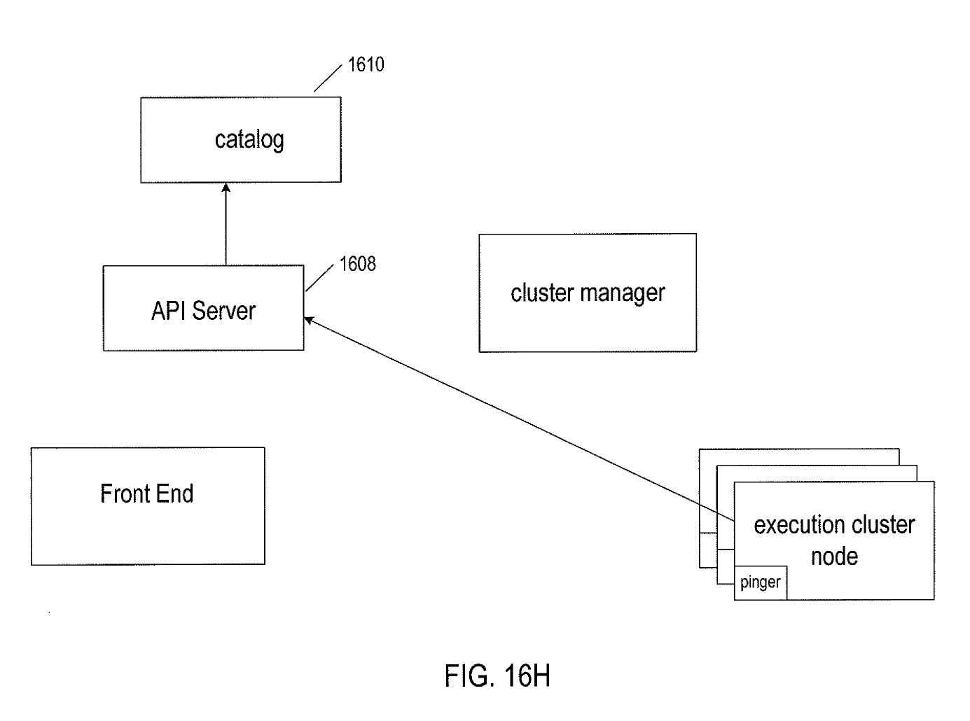

FIGS. 16A-I illustrate the process of experiment design and execution within the scientific-workflow system. FIGS. 16A-I all use the same illustration conventions, with blocks illustrating the scientific-workflow-system components previously discussed with reference to FIG. 12. In an initial experiment-design phase, the front-end experiment-dashboard application, running on a user computer or other processor-controlled device, provides a user interface that allows a user to construct a visual representation of an experiment design, or experiment DAG 1604. The visual representation is based on a JSON encoding of the DAG 1606, described above with reference to FIGS. 13C-D and FIGS. 15A-I. The front-end experiment-dashboard application calls various DAG-editor-tool services and search services provided by the API-server component 1608 of the scientific-workflow-system back end. The API-server component 1608, in turn, makes calls to, and receives information from, the catalog service 1610. In constructing an experiment design, a user may search for, and download previously developed experiment designs and components of experiment designs, the metadata for which is stored in the catalog 1610. Searching may be carried out with respect to the values of the various fields within catalog entries discussed above with reference to FIG. 14B. Users may also employ editing tools to construct entirely new experiment designs. Experiment designs may be named and stored in the catalog by users through various API-server services called from the front-end experiment-dashboard application. In one approach to experiment design, referred to as “cloning,” an existing experiment design is identified, by searches of experiment designs stored in the catalog, and displayed to the user by the front-end experiment-dashboard application. The user can then modify the existing experiment by changing data sources, adding, deleting, or changing execution modules and data-flow links between execution modules, and by adding or deleting instances of execution modules. Because information about previously executed experiments and jobs is maintained within the scientific-workflow system, those jobs within the modified experiment design that receive the same input as identical jobs in previously executed experiments need not be again executed, during execution of the current experiment. Instead, the data produced by such jobs can be obtained from the catalog for input to downstream jobs of the current experiment. Indeed, whole sub-graphs of a modified experiment design may not need to be executed during execution of the current experiment design when those sub-graphs have identical inputs and occur identically within the current experiment design.

As illustrated in FIG. 16B, once an experiment design has been developed, a user may employ front-end experiment-dashboard features to upload data sets and execution modules not already present in the catalog to the catalog via upload services provided by the API-server component 1608. As shown in FIG. 16C, once a user has either uploaded the necessary data sets and execution modules needed for executing an experiment that were not already present in the catalog, the user inputs experiment-submission features of the front-end experiment dashboard to submit the experiment design, as a JSON encoding of the corresponding experiment DAG 1612, to an experiment-submission service provided by the API-server component 1608 for execution. As shown in FIG. 16D, upon receiving the experiment design, the API-server component 1608 parses the experiment design into execution-module instances and data sets, interacts with the catalog service 1610 to ensure that all of the data sets and execution modules are resident within the catalog, validates the experiment design, computes job signatures for all execution-module instances, and interacts with the catalog to create new job entries for job signatures that do not match the job signatures of job entries already stored in the catalog, receiving job identifiers for the newly created job entries. It is only the newly created job entries that need to be executed in order to execute the experiment.

As shown in FIG. 16E, the job identifiers for those jobs that need to be executed in order to execute the experiment are forwarded from the API-server component 1608 to the cluster-manager component 1614. The cluster-manager component distributes the received job identifiers among the execution-cluster nodes 1616 for either immediate execution, when all of the input data for the job corresponding to the job identifier is available, or for subsequent execution, once data dependencies have been satisfied. As shown in FIG. 16F, for those job identifiers corresponding to jobs waiting for dependency satisfaction, a pinger 1618 within the execution-cluster node to which a job identifier has been forwarded by the cluster-manager component continuously or intermittently polls the API-server component 1608 to determine whether or not the input-data dependencies have been satisfied as a result of the completion of execution of upstream jobs. When the dependencies have been satisfied, the job identifiers are then submitted for execution by the execution-cluster node. As shown in FIG. 16G, when an execution-cluster node prepares to launch execution of a job, the execution-cluster node downloads, via an API-server service, the necessary data sets and executables to local memory and/or other local data-storage resources. As shown in FIG. 16H, once a job finishes execution, the execution-cluster node transmits, through the API-server component 1608, the data sets generated by execution, standard error output and I/O output, and a completion status to the catalog 1610 for storage. As shown in FIG. 16I, when the API-server component 1608 determines that all jobs for an experiment have been executed, the API-server component can return an execution-completion indication to the front-end experiment-dashboard application 1602. Alternatively, the front-end experiment-dashboard application may poll the catalog through an API-server-component interface or service in order to determine when execution completes. Upon execution completion, the user may access and display output from the experiment on the front-end experiment dashboard.

The back-end activities discussed above with reference to FIGS. 16A-I are next described in greater detail. Prior to that discussion, various aspects of experiment design and experiment execution are next summarized. A first important aspect of the scientific-workflow system is that experiment designs consist of the conceptually straightforward execution modules and data sources. This, combined with the visual-editing tools, searching capabilities, and metadata storage in the system catalog, allows users to quickly construct experiments, often by reusing large portions of previously developed experiment designs. A second important feature of the scientific-workflow system is that, because jobs and the data output by successfully executed jobs are stored and maintained in the catalog, when a new experiment design that incorporates portions of a previously executed experiment is executed by the system, it is not necessary to re-execute identical jobs with identical inputs. Because the output from those jobs is stored, that output is immediately available to supply to downstream jobs as the experiment is executed. Thus, both the process of designing experiments and the computational efficiency of experiment execution are greatly enhanced by the comprehensive catalog maintained within the scientific-workflow system. Another important aspect of the scientific-workflow system is that all of the back-end components, other than the catalog, are stateless, allowing them to be straightforwardly scaled in order to support ever increasing numbers of users. The data and execution modules for executing jobs are stored locally on the execution cluster node on which the job is executed, which significantly ameliorates the communications bandwidth problems associated with distributed execution in large distributed systems. The scientific-workflow system decomposes an experiment into jobs corresponding to execution modules and executes the jobs in execution phases, with the initial jobs dependent only on named data sources or independent of external resources and subsequent phases of execution involve those jobs whose dependencies have been satisfied by previously executed jobs. This execution scheduling is coordinated by job-status information maintained by the catalog and arises naturally from the DAG description of an experiment.

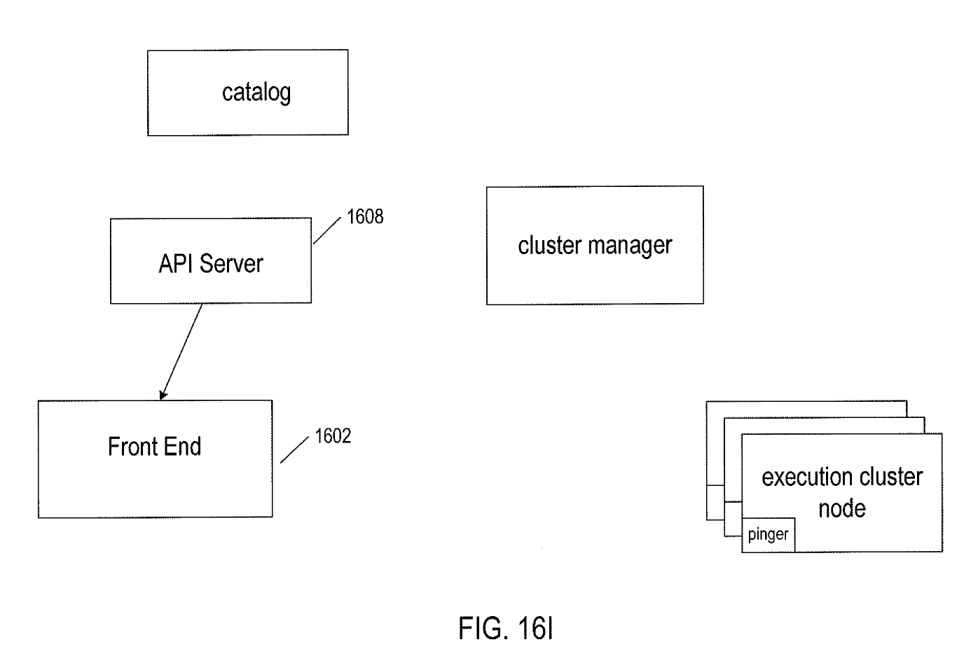

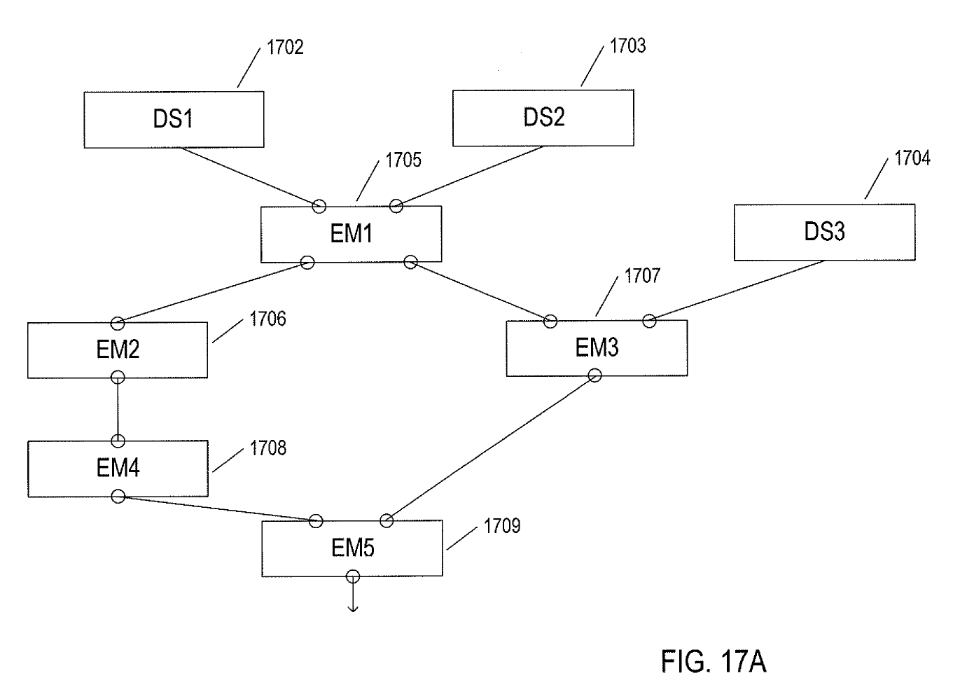

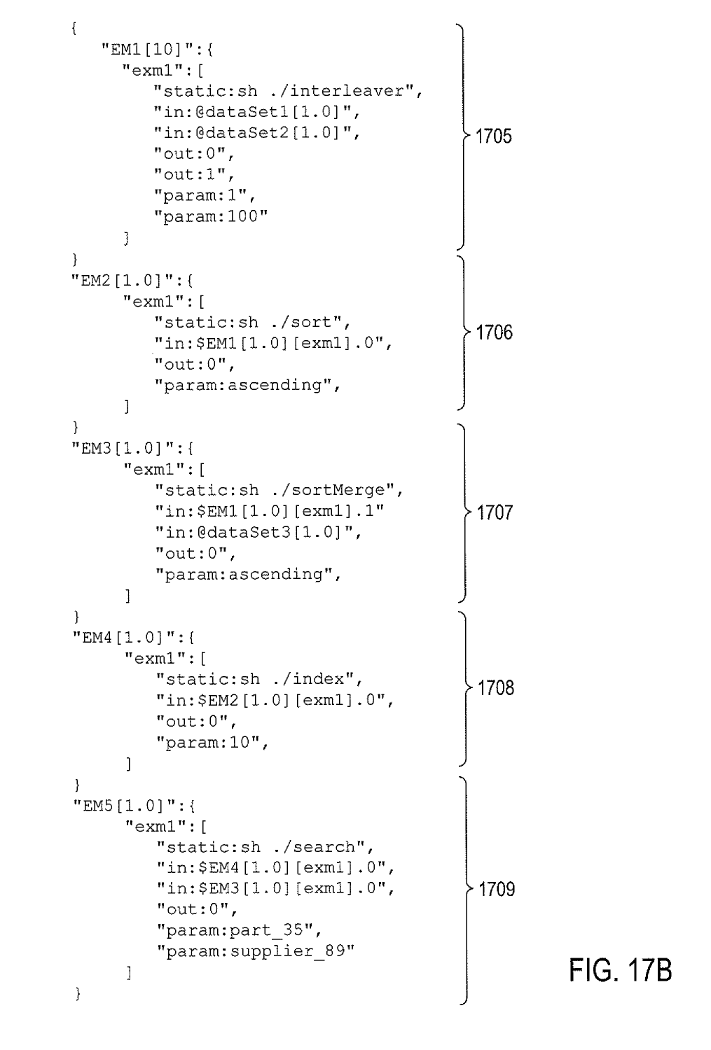

FIGS. 17A-B show a sample visual representation of an experiment DAG and the corresponding JSON encoding of the experiment DAG. As shown in FIG. 17A, the experiment design includes three data-source nodes 1702-1704 and five execution-module-instance nodes 1705-1709. In FIG. 17B, the numeric labels used in FIG. 17A for the execution-module nodes are again used to indicate the corresponding portions of the JSON encoding.

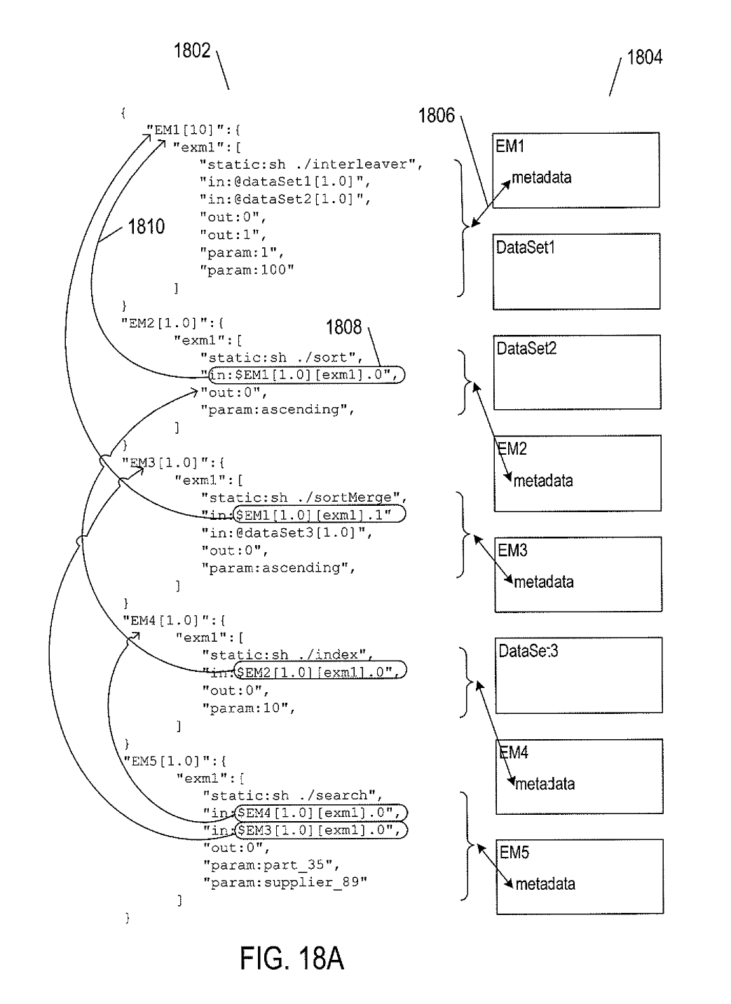

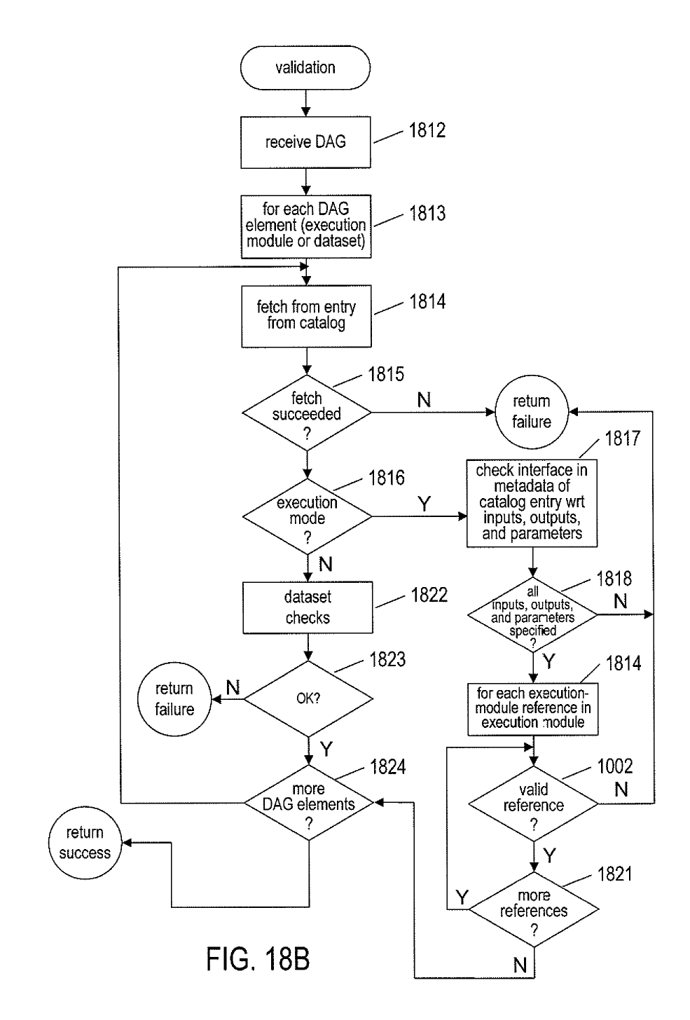

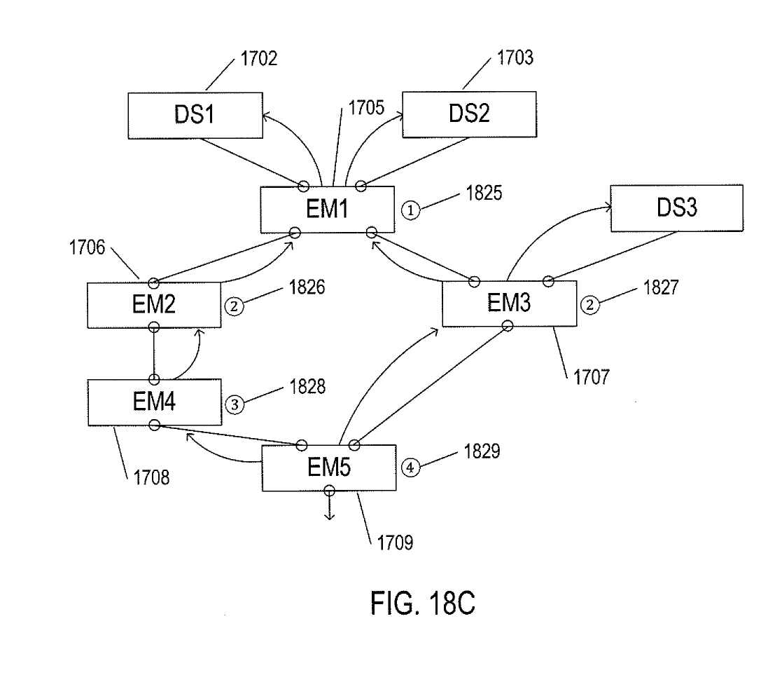

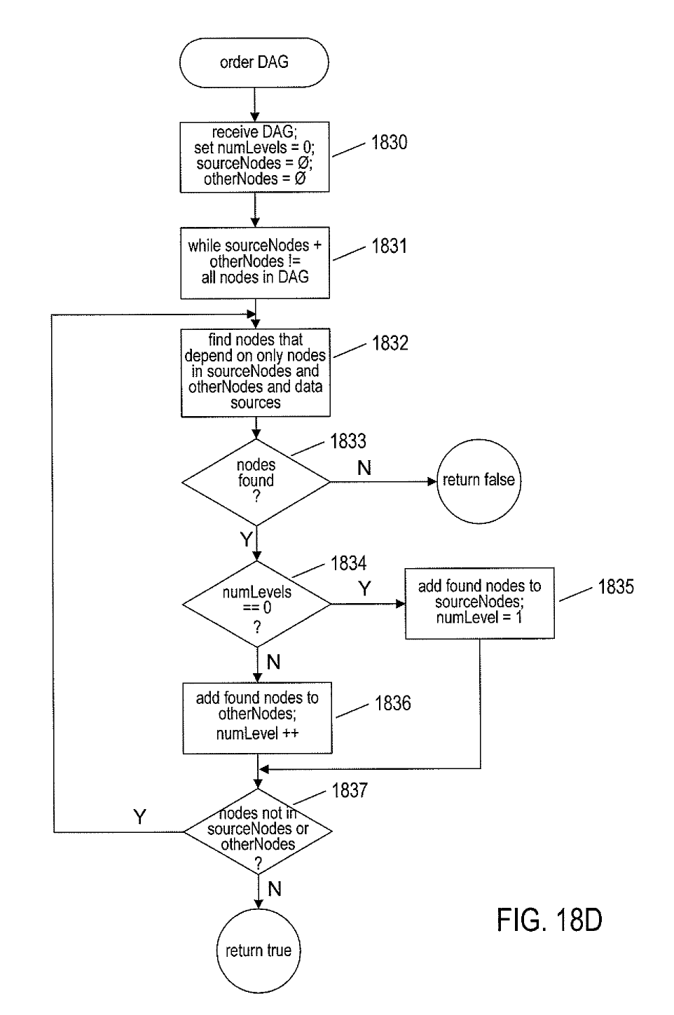

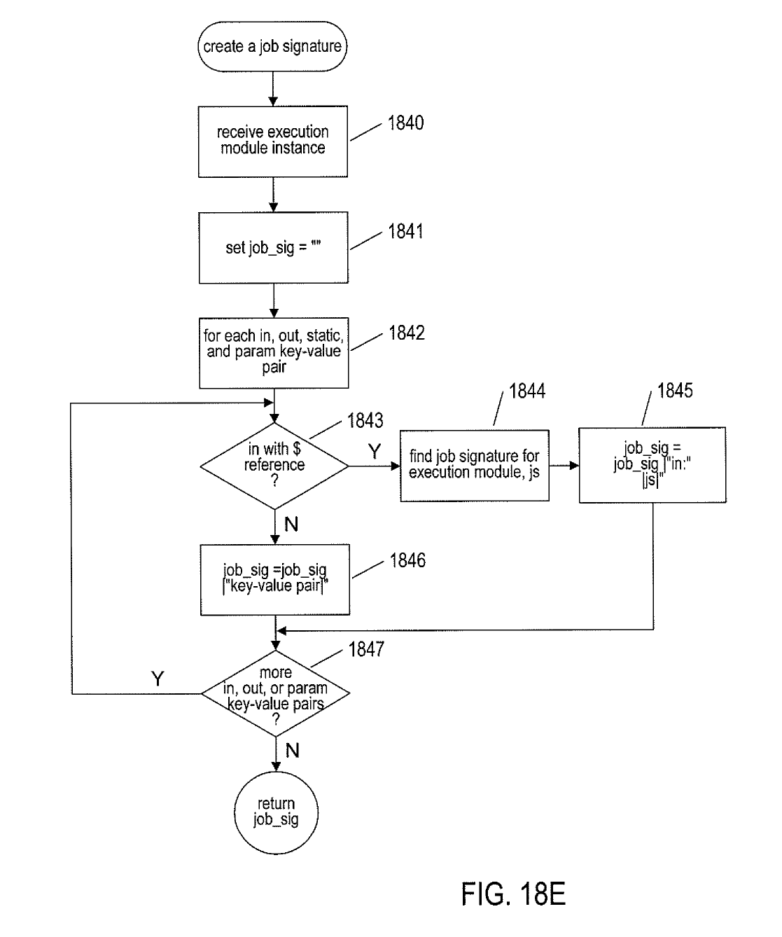

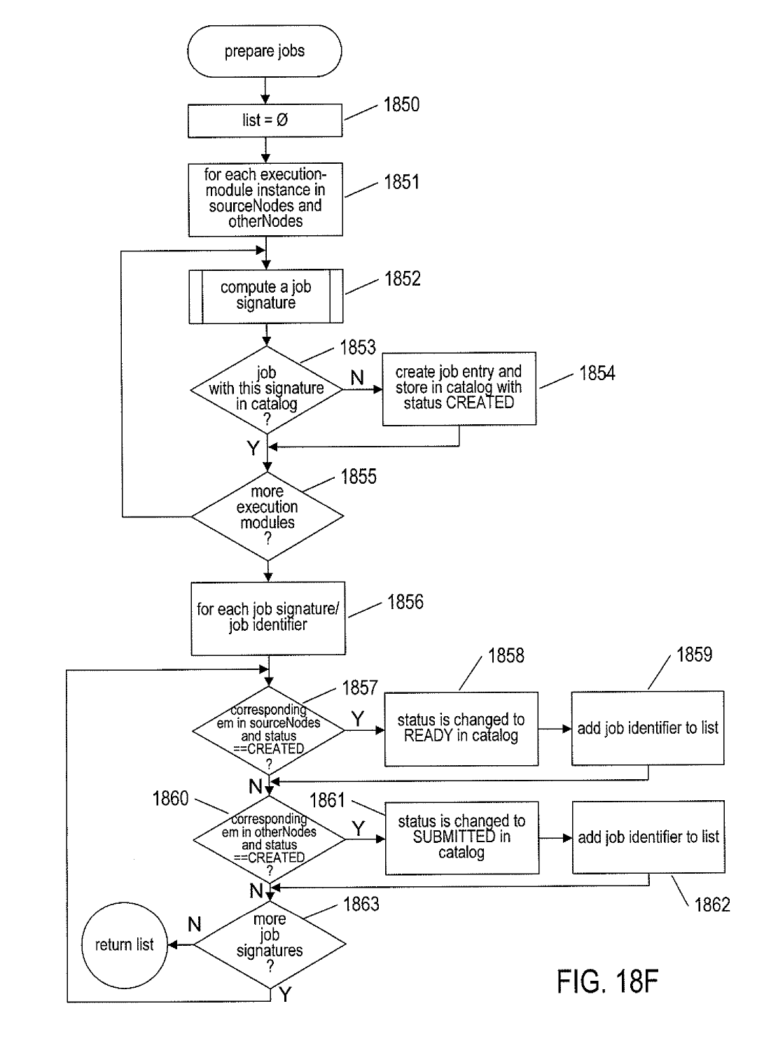

FIGS. 18A-G illustrate the activities carried out by the API-server component (1608 in FIG. 16A) of the scientific-workflow-system back end following submission of an experiment for execution by a user via a front-end experiment-dashboard application. FIG. 18A illustrates numerous different steps carried out during validation of an experiment design by the API-server. In FIG. 18A, the JSON encoding of the experiment DAG, shown above in FIG. 17B, is reproduced in a first left-hand column 1802. In a first step, the API-server identifies the execution modules and data sets within the experiment design and retrieves corresponding catalog entries for these components from the catalog, shown as rectangles in a second right-hand column 1804 in FIG. 18A. When the API-server is unable to identify and retrieve a catalog entry corresponding to each execution module and data source, the experiment submission is rejected. Otherwise, in a next step, the key-value pairs for each instance of an execution module is checked against the metadata interface within the corresponding catalog entry, the checking indicated in FIG. 18A by double-headed arrows, such as double-headed arrow 1806. When the interface specification fails to coincide with the key-value pairs in the JSON encoding of the experiment DAG, the experiment submission is rejected. Finally, each input key-value pair that references another execution module, such as the input key-value pair 1808, is checked against the experiment DAG to ensure that the input key-value pair references a first-level execution-module name, as indicated by curved arrows, such as curved arrow 1810.

FIG. 18B provides a control-flow diagram for the validation steps discussed above with reference to FIG. 18A. In step 1812, the routine “validation” receives an experiment DAG. In the for-loop of steps 1813-1824, each element of the DAG, where an element is an execution module or referenced data set, is checked. First, in step 1814, the corresponding entry from the catalog is fetched for the currently considered DAG element. When the catalog fetch does not succeed, as determined in step 1815, failure is returned. Otherwise, when the fetched entry is an execution module, as determined in step 1816, then, in step 1817, the interface on the metadata of the catalog entry is checked with respect to the inputs, outputs, and parameters of the execution module encoding in the experiment DAG. When the check of inputs, outputs, and parameters with respect to the interface metadata succeeds, as determined in step 1818, then, in the inner for-loop of steps 1819-1821, all of the input key-value pairs that include references to other execution modules are checked for validity, as discussed above with reference to FIG. 18A. When a reference is invalid, failure is returned. Otherwise, the currently considered element is validated. When the currently considered element is a data set, as determined in step 1816, then any data set validity checks are carried out in step 1822. These checks may include determining whether or not the data is accessible based on the data set catalog entry information. When the data set checks succeed, as determined in step 1823, then the data set entry is validated. The for-loop of steps 1813-1824 iterates through all of the experiment-DAG elements and returns success when all are validated.

FIGS. 18C-D illustrate ordering of an experiment DAG. FIG. 18C illustrates the order, or phases, for execution-module-instance execution. Execution module 1705 receives only data-source input from data sources 1702 and 1703. Therefore, execution-module instance 1705 can be immediately executed, in a first phase, as indicated by the circled phase number 1825. By contrast, execution modules 1706 and 1707 both depend on output from execution-module instance 1705. They must both therefore wait for completion of execution of execution-module instance 1705. They are therefore assigned to a second phase of execution, as indicated by the circled phase numbers 1826 and 1827. Execution-module instance 1708 depends on prior execution of execution-module instance 1706, and is therefore assigned to a third execution phase 1828. Finally, execution-module instance 1709 must wait for completion of execution of execution-module instance 1708, and is therefore assigned to a fourth execution phase 1829. These phase assignments represent an execution ordering of the experiment DAG. Of course, the point when an execution-module instance can be launched on an execution cluster node depends only on all data dependencies being satisfied, and not on the phase in which the execution-module instance is considered to reside.

FIG. 18D provides a control-flow diagram for a routine “order DAG” which determines an execution ordering for an experiment DAG. In step 1830, the routine “order DAG” receives an experiment DAG, sets a local variable numLevels to 0, and sets two local set variables sourceNodes and otherNodes to the empty set. Then, in the while-loop of steps 1831-1837, phases are determined iteratively until all of the nodes stored in the local-variable sets sourceNodes and otherNodes equal the total nodes in the experiment DAG. In step 1832, the routine finds all nodes in the experiment DAG that depend only on data sources and nodes in the sets sourceNodes and otherNodes. In step 1833, the routine determines whether any nodes were found in step 1832. If not, then the routine returns false, since the experiment DAG must either have cycles or other anomalies that would prevent execution ordering. Otherwise, when the value stored in the local variable numLevels is 0, as determined in step 1834, then the found nodes are added to the local set variable sourceNodes, in step 1835, and the variable numLevels is set to 1. Otherwise, the found nodes are added to the set otherNodes, in step 1836, and the variable numLevels is incremented by 1.

FIG. 18E provides a control-flow diagram for a routine “create a job signature.” A job signature is a type of unique fingerprint for a job corresponding to an execution-module instance. In step 1840, the routine receives a JSON encoding of an execution module instance. In step 1841, the routine sets a local variable job_sig to the empty string. Then, in the for-loop of steps 1842-1847, the routine appends each key-value-pair string to the job signature stored in the local variable job_sig. When the currently considered key-value pair is an input key-value pair with a reference to another execution module, as determined in step 1843, then the $-encoded reference is replaced by the job signature for the other execution module and the d-referenced input key-value pair is added to the job signature in steps 1844-1845. Otherwise, the key-value pair is added to the job signature in step 1846. Thus, a job signature is a concatenation of all the key-value pairs within an execution-module instance, with references to other execution modules replaced by job signatures for those execution modules.

FIG. 18F is a control-flow diagram for a routine “prepare jobs” that creates a list of job identifiers that is forwarded by the API server to the cluster-management component of the scientific-workflow-system back end to initiate execution of an experiment. In step 1850, the routine “prepare jobs” sets a local variable list to a null or empty list. Then, in the for-loop of steps 1851-1855, each execution-module instance stored in the source nodes and other nodes sets in a previous execution of the routine “order DAG” is considered. In step 1852, a job signature is computed for the execution-module instance. In step 1853, the routine “prepare jobs” determines whether this job signature is already associated with a job entry in the catalog. If not, then a new job entry is created and stored in the catalog, in step 1854, with the status CREATED. Then, in the for-loop of steps 1856-1863, each job signature and job identifier corresponding to the job signature obtained when the job is found in the catalog or created and stored in the catalog is considered. When the corresponding execution-module instance is in the sourceNodes set and the status of the job entry corresponding to the job identifier is CREATED, as determined in step 1857, then, in step 1858, the status is changed to READY in the job entry in the catalog and the job identifier is added to the list of job identifiers in step 1859. Otherwise, when the execution-module instance corresponding to the job signature is found in the set otherNodes and the status of the job entry for the job signature in the catalog is created, as determined in step 1860, then the status for the job entry is changed to SUBMITTED in the catalog and the job identifier is added to the list in step 1862. Thus, the list produced by the routine “prepare jobs” contains a list of job identifiers corresponding to execution-module instances that need to be executed during execution of the experiment. In many cases, the list contains fewer job identifiers than execution-module instances in the experiment DAG. This is because, as discussed above, those jobs with job signatures that match job signatures of previously executed jobs in the catalog need not be executed, since their data outputs are available in the catalog.

FIG. 18G provides a control-flow diagram for the routine “process DAG” that represents API-server processing of a submitted experiment design. In step 1870, the routine “process DAG” receives an experiment DAG. In step 1872, the routine “process DAG” calls the routine “validation” to validate the received experiment DAG. When validation fails, as determined in step 1874, the experiment submission fails. Otherwise, in step 1876, the experiment DAG is ordered by a call to the routine “order DAG.” When the ordering fails, as determined in step 1878, then experiment submission fails. Otherwise, in step 1880, a list of jobs that need to be executed in order to execute the experiment are prepared by a call to the routine “prepare jobs.” In step 1882, the list of job identifiers is forwarded to the cluster manager for execution. In step 1884, the routine “process DAG” waits for notification of successful completion of all the jobs corresponding to the job identifiers in the list or timeout of execution. When all jobs have successfully completed, as determined in step 1886, then the experiment submission is successful. Otherwise, the experiment submission is unsuccessful.

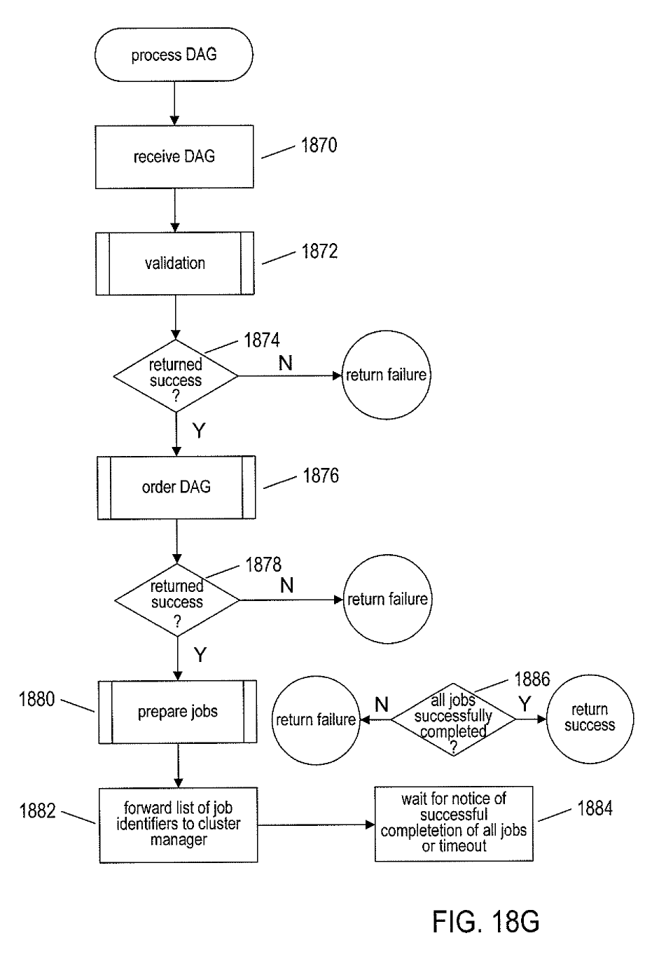

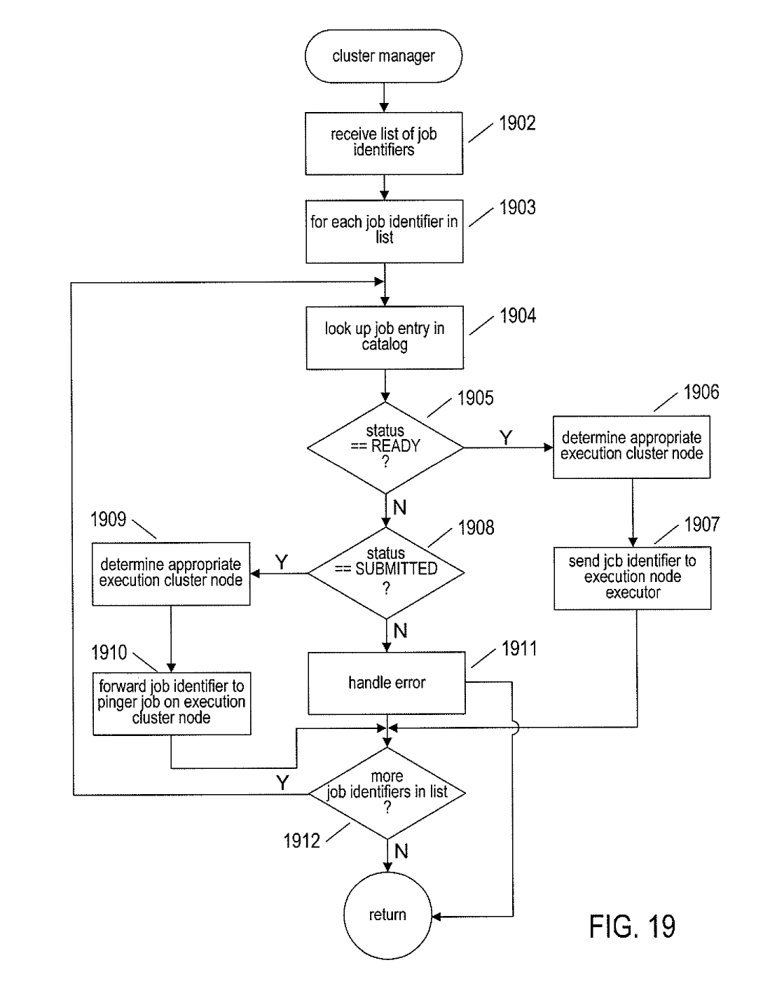

FIG. 19 provides a control-flow diagram for the routine “cluster manager” which executes on the cluster-manager component of the scientific-workflow-system back end to distribute jobs to execution cluster nodes for execution. In step 1902, the cluster manager receives a list of job identifiers from the API server. In the for-loop of steps 1903-1912, the routine “cluster manager” dispatches the jobs represented by the job identifiers to execution cluster nodes for execution. In step 1904, the routine “cluster manager” accesses, through the API server, the job entry corresponding to the job identifier in the catalog. When the status of the job entry is READY, as determined in step 1905, the routine “cluster manager” determines an appropriate execution cluster node for the job, in step 1906, and sends, in step 1907, the job identifier to the execution node executor for immediate execution. Determination of an appropriate execution-cluster node for executing the job, in step 1906, involves strategies to balance execution load across the execution cluster nodes as well as matching the resources needed for execution of the job to resources available on execution cluster nodes. In certain implementations, when there is insufficient resources on any execution cluster node to execute the job, the job may be queued for subsequent execution and the scientific-workflow system may undertake scaling operations to increase the computational resources within a cloud-computing facility available to the scientific-workflow system. When the status of the job entry is not READY as determined in step 1905, then when the status is SUBMITTED, as determined in step 1908, the routine “cluster manager” determines an appropriate execution cluster node for execution of the job, in step 1909, and then forwards the job identifier to a pinger executing within the determined execution cluster node in step 1910. If a pinger is not already executing on the execution cluster node, the routine “cluster manager” may access an execution-cluster-node interface to launch a pinger job in order to receive the job identifier. As mentioned above, the pinger continues to poll the catalog to determine when all dependencies have been satisfied before launching execution of the job identified by the job identifier. When the status of the job entry is neither READY nor SUBMITTED, then an error condition has obtained, which is handled in step 1911. In certain implementations, the job entry may have a status other than READY or SUBMITTED that indicates that the job is already queued for execution, perhaps in the context of another experiment. In such cases, execution of experiments that include the job may proceed.

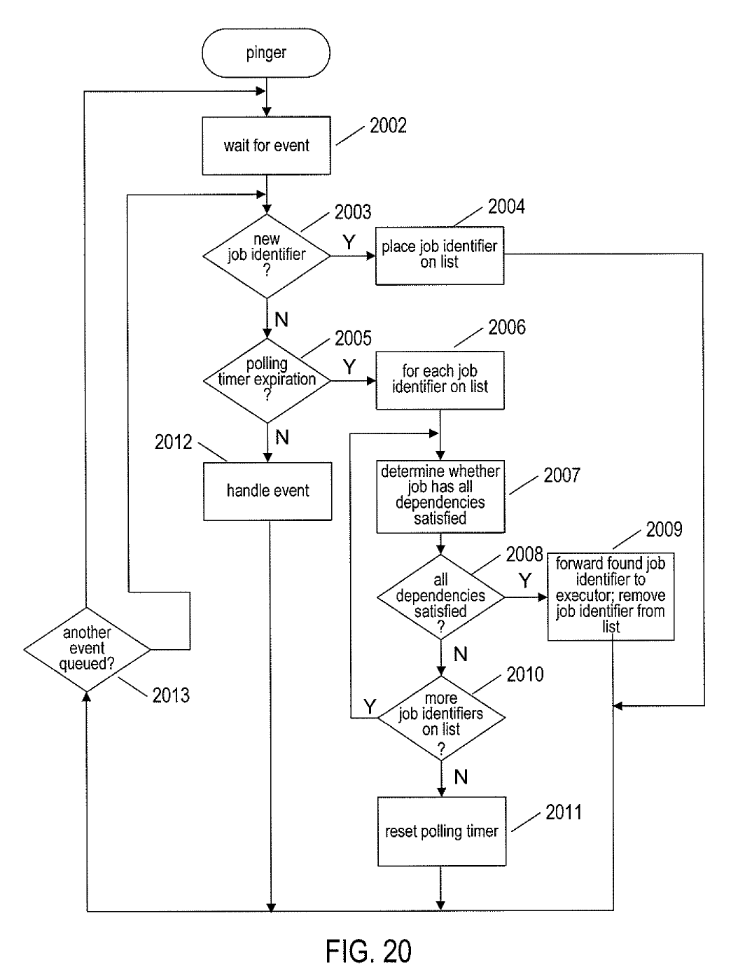

FIG. 20 provides a control-flow diagram for the routine “pinger.” As discussed above, a pinger runs within an execution cluster node in order to continue to check for satisfaction of dependencies of jobs associated with job identifiers received from the cluster manager in order to launch execution of the jobs. As discussed above, an experiment DAG is ordered into execution phases, with each job in a particular execution phase executable only when jobs in previous execution phases on which the job depends have completed execution and produced output data that is input to the currently considered job. In step 2002, the pinger waits for a next event. When the event is reception of the new job identifier, as determined in step 2003, then the job identifier is placed on a list of job identifiers that are being monitored by the pinger. When the next event is a polling-timer expiration event, as determined in step 2005, then, in the for-loop of steps 2006-2010, the pinger checks for satisfaction of dependencies for each job identifier on the list of job identifiers being monitored by the pinger. When all dependencies have been satisfied for a particular job identifier, as determined in step 2008, then the job identifier is forwarded to the executor within the execution-cluster node for execution of the job identifiers removed from the list of job identifiers being monitored. When all job identifiers on the list have been checked for dependency satisfaction, then the polling timer is reset, in step 2011. Other events that may occur are handled by a general event handler, in step 2012. When there is another event queued for consideration, as determined in step 2013, control flows back to step 2003. Otherwise, control flows back to step 2002, where the pinger waits for a next occurring event.

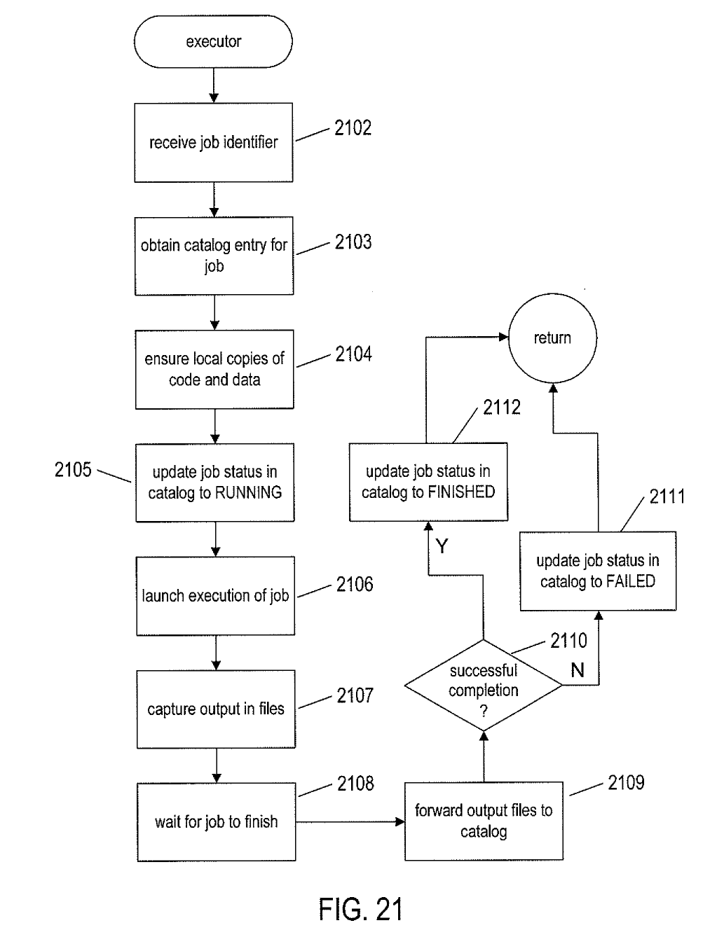

FIG. 21 provides a control-flow diagram for the routine “executor” that launches execution of jobs on an execution-cluster node. In step 2102, the routine “executor” receives a job identifier from the cluster-manager component of the scientific-workflow-system back end. In step 2103, the routine “executor” obtains a catalog entry for the job via the API server. In step 2104, the routine “executor” ensures that local copies of all input data and the executable for the job have been locally stored within the execution-cluster node to ensure local execution on the execution-cluster node. In step 2105, the job status of the catalog entry for the job is updated to RUNNING. In step 2106, the executor launches execution of the job. In certain implementations, a new executor is launched to receive each new job identifier forwarded to the execution-cluster node by the cluster manager. In other implementations, an execution cluster node is a continuously running executor for launching jobs corresponding to job identifiers continuously forwarded to the executor. The executor ensures that all of the output from the executing job is captured in files or other output-data storage entities. Then, in step 2108, the executor waits for the job to finish executing. Once the job finishes executing, the executor forwards the output files to the catalog. When the job has successfully completed execution, as determined in step 2110, the catalog entry for the job is updated to have the status FINISHED, in step 2112. Otherwise, the job entry for the catalog is updated to have the status FAILED, in step 2111.

Although the present invention has been described in terms of particular embodiments, it is not intended that the invention be limited to these embodiments. Modifications within the spirit of the invention will be apparent to those skilled in the art. For example, any of many different implementations may be obtained by varying any of many different design and implementation parameters, including choice of hardware platforms for the front end and back end, choice of programming language, operating system, virtualization layers, cloud-computing facilities and other data-processing facilities, data structures, control structures, modular organization, and many additional design and implementation parameters.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An automated experimentation platform comprising:
one or more processors;
one or more memories;
one or more data-storage devices; and
computer instructions stored in one or more of the memories and data-storage devices that, when executed on one or more or the one or more processors, control the automated experimentation platform to
provide a visual integrated development environment through which workflows comprising input data sets, execution modules, intermediate data sets, and output data sets linked together in a graph are created and displayed; and
execute workflows to produce output data sets.

2. The automated experimentation platform of claim 1 wherein the integrated development environment provides a dashboard display that includes:
a workflow-display panel;
input features through which data sets and execution modules are searched for among data sets and execution modules stored within the automated experimentation platform and incorporated into a workflow;
input features through which data sets and execution modules are downloaded from remote computer systems and incorporated into a workflow;
input features through which data sets, execution modules, and workflows are uploaded for storage within the automated experimentation platform; and
manipulation features through which data sets and execution modules are combined together to generate a workflow.

3. The automated experimentation platform of claim 1 wherein the integrated development environment provides a dashboard display that includes:
a workflow-display panel that
displays representations of execution modules, representations of data sets, and links between data sets and execution modules; and
provides a workspace in which workflow graphs are assembled from representations of data sets, representations of execution modules, representations of input data sets, and representations of output data sets.

4. The automated experimentation platform of claim 1 wherein a workflow represents an experiment, comprising one or more execution modules, that, when launched as a result of input to the visual integrated development environment, is executed by automated experimentation platform by executing the execution modules in one or more sequential execution phases during each of which one or more execution modules are scheduled for execution.

5. The automated experimentation platform of claim 4 wherein, during an execution phase, one or more execution modules are scheduled for execution by the automated experimentation platform by distributing the one or more execution modules among available execution cluster nodes for parallel execution.

6. The automated experimentation platform of claim 4 wherein the data sets input to the one or more execution modules that are scheduled for execution during an execution phase are either data sets initially input to the experiment or data sets that have been generated during execution of one or more preceding execution phases.

7. The automated experimentation platform of claim 4 wherein a workflow is an acyclic graph in which one or more input data sets are linked to one or more execution modules, execution modules are associated with one or more intermediate or output data sets, and intermediate data sets are linked to execution modules.

8. The automated experimentation platform of claim 1 further comprising:
a front end that comprises multiple front-end experiment dashboard applications that each executes on a user computer or other processor-controlled user device; and
a back end connected to the front end by a communications infrastructure including one or more of the Internet, personal area networks, local area networks, wide area networks, and communications sub-systems, the back end comprising one or more application-program-interface servers, a distributed catalog service, a cluster-management service, and multiple execution-cluster nodes implemented within one or more of one or more cloud-computing systems, one or more private data centers, and one or more aggregations of server computers, network-attached storage systems, internal networks, and main frames or other large computer systems.

9. The automated experimentation platform of claim 8 wherein the front-end experiment dashboards exchange information, requests, and responses with the application-program-interface servers using a RESTful communications model.

10. The automated experimentation platform of claim 8 wherein the application-program-interface servers
receive requests from, and send responses to, the front-end experiment-dashboard applications running on user computers;
carry out received requests by accessing services provided by the catalog service and cluster-management service; and
provide services to the execution cluster nodes and cluster-management service.

11. The automated experimentation platform of claim 8
wherein the automated experimentation platform stores
execution modules, executable sets of computer instructions and configuration data,
experiments, complex computational tasks represented by workflows that combine data sets and executable modules,
data sets, and
jobs, execution instances of execution modules; and
wherein the catalog service provides an interface to the stored execution modules, the stored experiments, the stored data sets, and the stored jobs.

12. The automated experimentation platform of claim 8 wherein the cluster-management service
receives, from the application-program-interface servers, job identifiers for jobs that need to be executed on the execution cluster nodes in order to carry out experiments; and
dispatches the jobs to appropriate execution cluster nodes for execution.

13. The automated experimentation platform of claim 12 wherein the cluster-management service
forwards jobs that are ready for execution to particular execution cluster nodes for immediate execution; and
forwards jobs that need to wait for data produced by currently executing jobs or jobs waiting for execution to pinger routines executing within execution cluster nodes, the pinger routines intermittently checking for satisfaction of dependencies in order to launch jobs for which dependencies have been satisfied.

14. The automated experimentation platform of claim 12 wherein, when a job has finished execution, the execution cluster node on which the job executed transmits output data and status information, via an application-program-interface server, to the catalog.

15. The automated experimentation platform of claim 8 wherein workflows that represent experiments are textually encoded in the JavaScript object notation.

16. The automated experimentation platform of claim 15 wherein a JavaScript-object-notation-encoded workflow comprises a list of JavaScript-object-notation-encoded execution modules, each including
an execution-module name;
a version number; and
encodings for each of one or more execution-module instances.

17. The automated experimentation platform of claim 16 wherein a JavaScript-object-notation-encoded execution-module instance includes:
an instance name or identifier; and
a list or set of key-value pairs, the key-value pairs encoding indications of the data inputs to the execution module, data outputs from the execution module, static parameters, and variable parameters for the execution module.

18. The automated experimentation platform of claim 1 wherein the integrated development environment provides cloning an experiment stored by the automated experimentation platform.

19. The automated experimentation platform of claim 18 wherein an experiment is cloned by:
identifying, by searches of experiment stored by automated experimentation platform, an experiment;
displaying a representation of the experiment by the integrated development environment;
modifying the experiment by one or more of changing data sources, adding execution modules, deleting execution modules, changing execution modules, and altering data-flow links between execution modules, adding instances of execution modules, and deleting instances of execution modules.

20. The automated experimentation platform of claim 19 wherein, because information about, and data sets produced by, previously executed experiments and instances of execution modules is maintained by the automated experimentation platform, instances of execution modules associated with the modified experiment that receive the same input as identical jobs in previously executed experiments need not be again executed during execution of the modified experiment.
